(19) United States
(12) Patent Application Publication
(10) Pub. No.: US 2026/0300922 A1
(43) Pub. Date: Oct. 1, 2026

(54) COMPLEX VIDEO DATA ANALYTICS FOR HIRING PRACTICES

(71) Applicant: Jogg, Inc., Hollywood, CA (US)

(72) Inventors: Christopher Daniel Ordal, Los Angeles, CA (US); William Edward Richards II, Northridge, CA (US); Zexing Jack Guo, Duarte, CA (US)

(21) Appl. No.: 19/096,541

(22) Filed: Mar. 31, 2025

(51) Int. Cl. G06Q 10/1053; G06F 16/783; G06V 10/74

(52) U.S. Cl. CPC G06Q 10/1053; G06F 16/7844; G06V 10/74

(57) ABSTRACT

A video analysis system may be configured to determine attributes of users associated with video data, and determine a score. For example, the video analysis system may receive first user input data from a first user, where the first user input data may indicate a selection of a first characteristics. Based at least in part on the selection of the first characteristic, the video analysis system may be configured to determine first prompts. The video analysis system may subsequently receive second user input data from a second user. Based on the second user input data, first user characteristics associated with the second user may be determined. Further, a correlation between the first characteristic and the first user characteristics may be determined. Based at least in part on the correlation, the video analysis system may be configured to determine a score associated with the second user and the first characteristic.

### BACKGROUND

Entities, such as corporations, organizations, and/or businesses, typically perform market research (e.g., qualitative research) with respect to their products and/or services. For example, market research is beneficial to gain insights regarding consumers' reactions and/or perceptions, such as before a product and/or service is made available to the public. Conventional methods of market research include consumer surveys, focus groups, and/or the like. Surveys may also be used by entities to gain insights regarding a workplace, event, and/or the like. Typically, the creation and dissemination of surveys is laborious, both content-wise and temporally. For example, entities must determine which questions to include in the survey and to whom the surveys are to be sent, as well as take the time to parse through large amounts of consumer responses. Furthermore, responses to surveys are typically one-dimensional, rigid, and omit particular details and nuances associated with the consumer, employee, participant, etc. Similarly, focus groups are costly, inconvenient for the consumers engaging in the focus group, require the use of an unbiased and qualified moderator, etc. Conventional focus groups also rely on manual review of responses of the focus group, which may require hours of analysis.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to analyze user videos and generate sentiment data associated with a user and/or entity, according to at least some examples.

FIG. 2 illustrates example components of a user device and the system of FIG. 1 that analyzes user videos and generates sentiment data, according to at least some examples.

FIG. 3 illustrates an example process and related user interfaces for the generation of video prompts and use thereof, according to at least some examples.

FIG. 4 illustrates an example process for further processing of user videos, according to at least some examples.

FIG. 5 illustrates an example process for the score determinations of users, according to at least some examples.

FIG. 6 illustrates an example process for filtering user videos for analysis and subsequent output, accordingly to at least some examples.

FIG. 7 illustrates an example process and related user interfaces for the use of templates to filter user videos and subsequent output, accordingly to at least some examples.

FIGS. 8A and 8B illustrate example user interfaces for user interaction and analytics, accordingly to at least some examples.

FIG. 9 illustrates a flow diagram of an example process for the generation of a machine learning model and the use of the same, according to at least some examples.

FIG. 10 illustrates a flowchart outlining an example method for complex video data analytics for sentiment determinations, according to at least some examples.

FIG. 11 illustrates a flowchart outlining an example method for prompt generation and use thereof for complex video data analytics, according to at least some examples.

FIG. 12 illustrates a flowchart outlining an example method for complex video data analytics and moderation, according to at least some examples.

FIG. 13 illustrates a flowchart outlining an example method for complex video data analytics and scoring determinations, according to at least some examples.

FIG. 14 illustrates a flowchart outlining an example method for the use of dynamic templates for video data filtration, analytics, and complex delivery.

### DETAILED DESCRIPTION

This application describes systems and techniques for complex video analytics for sentiment determinations (e.g., sentiments and/or attributes associated with a user, brand, entity, and/or the like) via a video analytics and decision system and/or service (hereinafter “video analysis system”). For example, a video analysis system may receive first user input data that has been provided by and/or received from a first user and/or entity. For example, the user input data may include video data, audio data, and/or the like (collectively referred to as “video data”). The video analysis system may further receive second user input data from a second user, wherein the second user input data at least partially includes second video data. When user data is received by the video analysis system, the video analysis system may be further configured to aggregate the associated video data, such as an aggregated first video data and second video data, as well as apply one or more transformations to generate text data associated with the aggregated video data. Further, based on the text data, the video analysis system may determine one or more attributes associated with the first video data and the second video data. The attributes may then be used to determine a sentiment associated with one or more users, entities, etc. Information such as the sentiments and/or text data associated with the aggregated user video data may be displayed and/or otherwise represented at a user interface accessible by another user, such as an entity.

In another example, the video analysis system may be configured to elicit particular information in user data. For example, the video analysis system may receive first data from a first user (e.g., individual, brand, entity, enterprise, etc.) indicating a request. In some instances, the request may include an indication to receive particular user feedback and/or response data. For example, the request may include an indication of information types, where the first user would receive particular user feedback and/or response data for the information types. The video analysis system may be configured to identify the information type based on the request. Further, based on the information types and/or the request, the video analysis system may determine a prompt, which may be sent to second users (e.g., individuals, consumers, etc.) as second data. The video analysis system may then receive third data from the second users, where the third data at least partially includes video data (e.g., a video response to the prompt). Based at least in part on the video data and computer vision techniques, the video analysis system may determine attributes, such as attributes of the user associated with the video data and/or attributes of the content associated with the video data. Based at least in part on the attributes, the video analysis system may generate response data (e.g., data indicating the identified attributes). Further, the response data may be included in a representation, such as a graphical representation. For example, the representation may be displayed at a user interface associated with the first user.

In another example, the video analysis system may be configured to moderate content between multiple users. For example, the video analysis system may receive video data from a first user, and apply one or more transformations to the video data to generate text data representing the content of the video data (e.g., a transcription of the content of the video data), wherein the text data is at least partially associated with a searchable format. Based on the text data, information types associated with the content of the video data may be determined. For example, information types may indicate particular portions of the text data pertaining to a particular topic. Additionally, or alternatively, the video analysis system may receive user input data from the first user or a second user, which may include an indication of a particular information type from the information types, and where receiving the user input data may at least be partially associated with the searchable format of the text data. A first segment of the text data that is associated with the particular information type may be determined. The video analysis system may also be configured to correlate, or otherwise identify, first video data that is represented by the first segment. The video analysis system may also be configured to store a representation of the first video data.

In another example, the video analysis system may be configured to determine attributes of users associated with video data, and determine a score associated with the users. For example, the video analysis system may receive first user input data from a first user, where the first user input data may indicate a selection of a first characteristics from a group of characteristics. Based at least in part on the selection of the first characteristic, the video analysis system may be configured to determine first prompts from a group of prompts, where the prompts at least partially correspond to the first characteristic. The video analysis system may subsequently receive second user input data from a second user, where the second user input data is based at least in part on the first prompts (e.g., responsive to the first prompts). In some examples, the second user input data may include video data, audio data, and/or the like. Based on the second user input data and using a first machine learning model, first user characteristics associated with the second user may be determined. Further, a correlation between the first characteristic and the first user characteristics may be determined. Additionally, or alternatively, based at least in part on the correlation and by a second machine learning model, the video analysis system may be configured to determine a score associated with the second user and the first characteristic. The video analysis system may then be configured to transmit a representation of the score to the first user.

In another example, the video analysis system may be configured to determine templates for filtering video data and subsequent output. For example, the video analysis system may be configured to receive video data from a user and determine, based at least in part on the video data, a template that is executable in a computer-centric format. The video analysis system may further receive, based at least in part on the template, user input indicating an instruction from a group of instructions associated with the video data such that a limited amount of the group of instructions is processed in a manner that saves processing power. The video analysis system may also determine, based at least in part on the instruction, a portion of the video data requiring a smaller amount of storage than the video data. The video analysis system may further be configured to determine, based at least in part on the instruction and the portion of the video data, an attribute associated with the portion of the video data such that a limited amount of video data is processed in a manner that saves processing power, wherein the attribute corresponds to the instruction. The video analysis system may further determine output data including an indication of the attribute, generate a representation of the output data, and cause the representation to be displayed at a user interface.

Traditionally, as discussed above, entities, such as corporations, organizations, and/or businesses, typically perform market research (e.g., qualitative research) with respect to their products and/or services. For example, market research is beneficial to gain insights regarding consumers' reactions and/or perceptions, such as before a product and/or service is made available to the public. Conventional methods of market research include consumer surveys, focus groups, and/or the like. Surveys may also be used by entities to gain insights regarding a workplace, event, and/or the like. Typically, the creation and dissemination of surveys is laborious, both content-wise and temporally. For example, entities must determine which questions to include in the survey and to whom the surveys are to be sent, as well as take the time to parse through large amounts of consumer responses. Furthermore, responses to surveys are typically one-dimensional, rigid, and omit particular details and nuances associated with the consumer, employee, participant, etc. Similarly, focus groups are costly, inconvenient for the consumers engaging in the focus group, require the use of an unbiased and qualified moderator, etc. Conventional focus groups also rely on manual review of responses of the focus group, which may require hours of analysis.

Described herein are, at least in part, techniques including the analysis of video data, filtration of video data, and the generation of sentiments, prompts, scores, and/or the like such that entities may gain valuable insights regarding the video data. The techniques described herein may be applicable in various scenarios, including scenarios where a user and/or entity would like to gain insights regarding products, services, particular users, employees, and/or the like. Various examples of the present disclosure include systems, methods, and non-transitory computer-readable media of a video analysis system.

A user of a video analysis system may include an individual user, business, corporation, entity, enterprise, and/or the like (collectively referred to as “entity”). For example, the entity may use the video analysis system in order to gain insights via video data for products and/or services associated with the entity. In some instances, the entity may use the video analysis system in order to gain insights via video data for internal procedures, employee feedback, event content, and/or the like. For example, the entity may provide user input data to the video analysis system, which may indicate a request for video data from one or more users. Additionally, or alternatively, the video analysis system may receive user data from the one or more users, which may include video data, audio data, image data, and/or the like (collectively referred to as “video data”). For example, the video data may include a video recorded by the user, a video depicting the user and/or the user speaking, a video of the environment of the user and/or the user speaking, etc. In some examples, the video data from the one or more users may be provided to the video analysis system in response a prompt, as described in more detail below. In some examples, the video data from the one or more users may be provided to the video analysis system unprompted. Additionally, or alternatively, the video analysis system may be configured to receive user data, and in turn, video data, from multiple users. In instances where the video analysis system receives video data from multiple users, the user data and/or video data may be aggregated and/or stored collectively such that the user data is accessible to the entity. For example, the user data may be accessible via a user interface associated with the video analysis system.

In some examples, the video analysis system may be configured to apply one or more transformations to the aggregated user data and/or video data in order to generate text data. The text data may represent the content of a video associated with the video data. For example, the text data may represent user utterances, phrases, and/or otherwise transcribe the content of the video. In some examples, the text data may be associated with a searchable format. Additionally, or alternatively, the video analysis system may be configured to determine attributes associated with the video data and/or text data. In some examples, the attributes may include attributes of the user associated with the video data. For example, the attributes may indicate a demeanor, voice inflection, conduct, behavior, attitude, and/or the like of a user included in the video. Additionally, or alternatively, the attributes may include attributes of the content of the video data. For example, the attributes may indicate positive language (e.g., a user in the video saying “I love this commercial”) and/or negative language (e.g., a user in the video saying “I really did not like how long this commercial was”). In some instances, the attributes may be determined using a machine learning model that is trained to determine attributes based on text data, video data, and/or the like. For example, the video analysis system may use computer vision techniques to determine attributes based on video data.

Based on the attributes, the video analysis system may determine sentiments. The sentiments may be associated with the entity and/or the user in the video. For example, sentiments associated with the entity may include a user value, feeling, perspective, etc. associated with a brand, entity, etc. In some instances, sentiments may include any information that may be usable by a brand and/or entity to gain user (e.g., consumer, employee, etc.) insights. Additionally, or alternatively, sentiments may be determined by the video analysis system on a per-user and/or per-video basis (e.g., for each user and associated video data), or the sentiments may be determined by the video analysis system for an entire aggregation of video data (e.g., sentiments representing the content included in all user videos, determined based on the sentiment of the first user and the sentiment of the second user). For example, in instances where user data has been received from multiple users, a sentiment may be determined for a first user based on their respective video data, and another sentiment may be determined for a second user based on their respective video data. The video analysis system may be configured to use both sentiments to determine an overall sentiment associated with the entity. Additionally, or alternatively, the video analysis system may be configured to determine sentiments associated with video data as a function of time. For example, attributes associated with the video data may indicate a positive sentiment at a first instance of the video data, and a negative sentiment at a second instance of the video data. As part of this, the video analysis system may be configured to correlate individual times comprising the video data with individual sentiments. In some instances, the sentiments may be determined using a machine learning model that is trained to determine sentiments based on attributes.

Additionally, or alternatively, sentiment data may be provided to the entity. For example, the video analysis system may be configured to generate a representation including the aggregation of user data (e.g., an aggregation of video data), an indication of the sentiments, the text data, and/or the like. Additionally, or alternatively, the representation may include an indication of the sentiments associated with video data as a function of time. The representation may further be displayed at a user interface associated with the video analysis system and accessible by the entity. Additionally, or alternatively, the user interface may be configured to further receive user input data from the entity (e.g., agents of the entity). For example, an agent of the entity may provide user input data indicating a selection of a portion of the text data. In other words, the agent may otherwise “highlight” a portion of the text data. For example, the agent may highlight a portion of the text data based on the portion being of particular importance to the agent and/or entity. Accordingly, the video analysis system may update the representation at the user interface to include an indication of the selected portion of the text data. For example, the video analysis system may include an indication of a portion of the video data that corresponds to the selected portion of the text data.

In some instances, an agent associated with an entity may select, or highlight, multiple portions of the text data, which may correspond to different portions of the video data. Additionally, or alternatively, the video analysis system may be configured to determine a correlation between the multiple portions such that a category associated with the multiple portions may be determined. By way of example, and not limitation, the agent may select a first portion of the text data, which may include text representing a user in a video saying, “I thought the music was really obnoxious.” Additionally, or alternatively, the agent may select a second portion of the text data, which may include text representing the user in the video saying, “I did not like the style of the music.” As such, the category associated with the first and second portions may include a music categorization, negative reviews categorization, etc. The video analysis system may subsequently update the representation at the user interface to include an indication of the determined category, where the determined category may further include portions of the video data associated with the first and second portions of the text data. Additionally, or alternatively, the category determined by the video processing system may be used subsequently to identify other portions of text data and/or video data.

Additionally, or alternatively, the video analysis system may be configured to further process the aggregation of user data such that only particular users, attributes, and/or video data is included as part of the aggregation of user data. In some instances, the video analysis system may use, or work in combination with, a machine learning component to filter the aggregation of user data. For example, an agent associated with an entity may indicate a particular attribute from the attributes associated with the aggregation of user data. By way of example, and not limitation, the agent may indicate a particular attribute such as confidence, openness, authentic, etc. Additionally, or alternatively, the video analysis system may be configured to determine a particular attribute from the attributes associated with the aggregation of user data. For example, the video analysis system may determine the particular attribute based on user input data associated with the entity (e.g., the user input data indicating a particular business purpose, goals, etc.). Based on the particular attribute indicated by an agent of the entity and/or determined by the video analysis system, the video analysis system may be configured to filter the aggregation of the user data. For example, based on user data from a first user including video data that is associated with the particular attribute, the user data from the first user may be included in the aggregation of user data. Additionally, or alternatively, based on user data from a second user including video data that is not associated with the particular attribute, the user data from the second user may not be included in the aggregation of user data. With the user data from the second user not being included in the aggregation of user data, the video analysis system refrains from generating sentiment data based on the user data from the second user. This way, only a portion of the user data may be processed, as opposed to all of the user data, in a manner that saves processing power. Accordingly, by filtering the aggregation of user data, the video analysis system may optimize the use of computing resources (e.g., memory, central processing units (CPUs), and/or the like).

As described above, the video analysis system may use, or work in combination with, a machine learning component. In some instances, the machine learning component may include machine learning models configured to determine attributes associated with video data and/or sentiments. Additionally, or alternatively, the machine learning component may further include a machine learning model configured to generate trend data indicating trends associated with the aggregated video data, such as sentiment trends. For example, the trend data may include an indication of a sentiment trend across user demographics, at different temporal instances (e.g., user data captured at a first instance vs. user data captured at a second instance), and/or the like. In some examples, trend data, such as a sentiment trend, may be generated irrespective of user input data by the entity. For example, user input data by the entity may indicate a request for trend data for a first sentiment. However, the video analysis system may generate trend data for a second sentiment (e.g., in instances where trend data for the second sentiment may include better insights than the trend data for the first sentiment).

In some additional examples, the video analysis system may be configured to generate and/or use prompts in the analysis of video data. This way, an entity and/or the video analysis system may elicit particular information in the user data (e.g., particular content associated with video data). For example, the video analysis system may receive user input data from an entity, where the user input data may include a request from the entity (e.g., a request to receive particular user feedback and/or response data). The video analysis system may be configured to, based on the user input data and/or other types of data, generate a prompt, such as a video invitation that is sent to end users with instructions for the end users to provide video feedback.

For example, user input data from an entity may include an indication of a prompt and/or a request for the video analysis system to generate a prompt. For example, the request may include an indication of information types, where the entity would receive particular user feedback and/or response data for the information types. An information type may include an indication of a purpose associated with the entity (e.g., general engagement, contest, video for use, feedback, and/or the like). Additionally, or alternatively, the video analysis system may be configured to identify information types based on the request and/or the user input data. For example, the video analysis system may use, or work in combination with, a machine learning component. The machine learning component may include a machine learning model (e.g., generative artificial intelligence) configured to generate prompts, or video invitations, for end users based on user input data from an entity and/or other types of data (e.g., user data, sentiment data, etc.). Further, based on the information types and/or the user input, the video analysis system may determine the prompt, which may be sent to one or more users (e.g., individuals, consumers, etc.). By way of example, and not limitation, based on a request including an information type indicating a purpose of general engagement, the video analysis system may be configured to determine a prompt to be sent to the one or more users, such that the video analysis system may receive user data from the one or more users containing video data associated with general engagement.

Additionally, or alternatively, the video analysis system may be configured to use an information type and/or prompt to remove user data from a particular user. For example, the information type and/or prompt may indicate a purpose associated with the entity to receive feedback regarding a football movie. Accordingly, the video analysis system may receive user data from one or more users in response to the prompt. In some examples, the video analysis system may determine a correlation between the user data and the prompt and/or information type. For example, user data may include first user data from a first user, wherein the first user data includes video data of a video in which the first user is talking about the football movie. Additionally, or alternatively, user data may include second user data from a second user, wherein the second user data includes video data of a video in which the second user only discusses the weather. The video analysis system may determine that the first user data has a first correlation value (e.g., 10 on a scale of 1-10), and may determine that the second user data has a second correlation value (e.g., 1 on a scale of 1-10.) The video analysis system may further determine that the first correlation value does not violate a threshold correlation value (e.g., a threshold of 5 on the scale of 1-10), and may determine that the second correlation value violates the threshold correlation value. Accordingly, the video analysis system may remove data pertaining second user data (e.g., video data, text data, sentiment data, etc.) from the response data.

In some examples, the video analysis system may determine an instance (e.g., time) and/or context at which a prompt is to be sent and/or made available to one or more users. The video analysis system may use an information type and/or prompt to determine the instance and/or context at which prompt data indicating the prompt is to be sent and/or made available to one or more users. For example, the information type and/or prompt may indicate a purpose associated with the entity to receive feedback regarding a football movie. Accordingly, the video analysis system may be configured to determine that the prompt associated with receiving feedback regarding a football movie is to be made available during a professional football game (e.g., displaying a prompt, or video invitation, at a user interface of an end user while a professional football game is airing), and at a peak time (e.g., 5 P.M. on a Sunday). As such, the video analysis system may be configured to send prompt data indicating the prompt such that the prompt is sent, made available, and/or displayed to one or more users at 5 P.M. on a Sunday during a professional football game. While prompt data may be sent directly to one or more users (e.g., to user devices), the video analysis system may further be configured to generate a link, quick-response (QR) code, and/or the like to display at one or more user devices, such that the one or more users may access the prompt and provide user input data. This way, links, QR codes, and/or the like may be displayed at one or more user devices without interrupting content associated with the user devices. In some instances, a prompt may be displayed at a device for mass-audience broadcasting and streaming.

Additionally, or alternatively, the video analysis system may receive user data from one or more users in response to a prompt, and may further be configured to determine attributes associated with the users. For example, the video analysis system may determine attributes associated with the users, the video data included in the user data, and/or the like. The attributes may indicate a demeanor, voice inflection, conduct, behavior, attitude, and/or the like of a user included in the video. The attributes may include attributes of the content of the video data. In some instances, the attributes may be determined by the video analysis system based on computer vision techniques. The video analysis system may be configured to determine attributes based at least in part on the information types included in, and/or identified from, the request and/or user input data of the entity. By way of example, and not limitation, based on a request including an information type indicating a purpose of general engagement, the video analysis system may be configured to determine attributes that correspond to general engagement. Additionally, or alternatively, based on the attributes determined by the video analysis system, the video analysis system may further be configured to generate response data for the entity. For example, response data may include an indication of the attributes, sentiments determined based on the attributes, analytics, feedback, insights, etc. associated with the user data received by the video analysis system. For example, the response data may include video data (e.g., video data from multiple users), text data representing the content of the video data, different portions of video data, sentiment data, and/or the like.

In some examples, the video analysis system may be configured to identify outliers in the user data. For example, the video analysis system may receive user data, including associated video data, from multiple users. The video analysis system may use, or work in combination with, a machine learning component to format user data as input embeddings for a machine learning model. For example, the machine learning component may include transformer models, neural network(s), and/or the like that are trained to output embeddings based at least in part on the user data. The machine learning component may be configured to group, or cluster, similar user data embeddings (e.g., using an embedding space). This way, the machine learning model may identify outliers in the user data. For example, user data associated with a first user may be formatted as a first embedding (e.g., a vector input), and user data associated with a second user may be formatted as second embedding. The video analysis system may determine that the first embedding is different than the second embedding. Accordingly, the video analysis system may update the response data to indicate the difference between the user data associated with the first user and the user data associated with the second user. Additionally, or alternatively, the video analysis system may be configured to store, maintain, etc. embeddings and/or other representations (e.g., embeddings for all user data received by the video analysis system on behalf of an entity). The embeddings and/or other representations may be usable by the machine learning component for subsequent determinations, such as the techniques described herein.

In some examples, the video analysis system may be configured to further process video data and/or moderate content between multiple users. For example, the video analysis system may receive user data, which may include video data, from an entity and/or user. In some instances, the video data may be longer in duration (e.g., associated with a video representing the content of a week-long conference). Additionally, the entity may be associated with the content of the video included in the video data (e.g., an administrator of the conference, and/or the like). In some examples, the entity may be able to enable, restrict, and/or otherwise control access to the video data. For example, the video analysis system may receive user data from the entity, which may include video data. Additionally, or alternatively, the video analysis system may receive user input data from the entity, which may indicate access controls associated with the video data. For example, the access controls may include particular user accounts that are allowed to access the video data, user accounts associated with the video data (e.g., an attendee of the conference), device types that are allowed access to the video data, and/or other access control lists (ACLs). Additionally, the access controls may include a particular duration of time in which a user, user account, device type, etc. has access to the video data. For example, the access controls may include a threshold period of time for accessing the video data. The threshold period of time may be associated with the video data, and/or may be associated with a particular user (e.g., different users have different periods of time in which they can access the video data). In some examples, users may access the video data through a user interface associated with a user device, which may be communicatively coupled to the video analysis system. Additionally, or alternatively, the user device may be communicatively coupled to the video analysis system through a service provider platform, such as a content moderation platform.

As described above, the video analysis system may apply one or more transformations to the video data to generate text data representing the video data (e.g., a transcription of the content of the video associated with the video data). In some examples, the text data may be associated with a searchable format. Based on the text data, information types associated with the content of the video data may be determined. For example, information types may include particular portions of the text data pertaining to a particular topic. Further, the video analysis system may receive user input data from the entity, or from one or more additional users, which may include an indication of a particular information type from the information types. For example, the user input data may include a “search” from the first user and/or the second user (e.g., a search for a particular word, phrase, person, etc.), an indication of a particular portion of the text data (e.g., a user “highlight” of the text data), and/or the like. In some examples, the video analysis system may use, or work in combination with, a machine learning component to identify information types associated with, and/or included in, the text data and associated with the video data. Additionally, or alternatively, the video analysis system may use, or work in combination with, a machine learning component to perform voice and/or facial recognition techniques with respect to the video data to generate voice data and/or facial data. Based at least in part on the voice data and/or facial data, information types may be identified and/or determined.

Additionally, or alternatively, segments of the text data that are associated with the particular information type may be determined and/or identified. For example, the video analysis system may identify a first segment of text data (e.g., for a transcription of a week-long conference, a segment on a particular panel provided at the conference) and a second segment of text data (e.g., for the transcription of the week-long conference, a segment on ancillary information to the conference, such as catering). The video analysis system may also be configured to correlate, or otherwise identify, video data that is represented by the segments (e.g., the portion of the video data that corresponds to text data included in the first segment). The video analysis system may also be configured to store a representation of the video data that is represented by the segments. This way, the entity may be able to access particular portions of the full-length video data easily and quickly. Additionally, or alternatively, as described above, the entity may enable users to access the video data. Similarly, one or more additional users may be able to provide user input data indicating a particular information type, where segments of the text data that are associated with the particular information type may be determined and/or identified. The video analysis system may further be configured to generate a representation, or heat map, of user input data indicating particular information types. For example, in instances where multiple users provide user input data indicating the same information type, the representation may include an indication of the same information type being prevalent, popular, and/or otherwise associated with multiple users. Additionally, or alternatively, a device associated with the entity may be communicatively coupled to the video analysis system through the service provider platform, such as a content moderation platform. As such, the representation (e.g., heat map) of user input data indicating particular information types may be displayed for the entity at the content moderation platform.

In some examples, the video analysis system may be configured to identify additional segments of text data associated with a particular information type. By way of example, and not limitation, in instances where the first segment of text data is associated with video content such as a particular panel provided at a conference, the video analysis system may identify additional segments of text data associated with the particular panel provided at the conference, and store a representation of both the first segment of text data and the additional segments of text data. Additionally, or alternatively, the video analysis system may identify segments of text data and/or portions of the video data that is represented by the segments based on other video data. For example, a user may indicate a particular information type (e.g., a sentiment), and the video analysis system may be configured to identify segments of text data and/or portions video data associated with the particular information type. In some examples, the video analysis system may identify portions of video data based on other portions of video data. For example, the video analysis system may identify a portion of video data based on text data, particular information types, etc. Additionally, or alternatively, the portion of video data identified by the video analysis system may be further used to identify additional portions of video data (e.g., using voice and/or racial recognition techniques to identify similar speakers, participants, etc. between portions of video data). The video analysis component may be configured to group additional segments of text data and/or portions of video data together based. For example, portions of video data may be grouped together based on a similar information type (e.g., portions of video data that each contain the same, or similar, person). The video analysis system may store a representation of the additional portions of video data, such that an entity or user is not required to parse through all content of full-length video data.

In another example, the video analysis system may be configured to determine attributes of users associated with video data, and determine a score associated with the users. By way of example, and not limitation, the video analysis system may be used by an entity, such as a hiring entity, in order to identify users, such as job applicants, that are qualified for a position associated with the hiring entity. For example, the video analysis system may receive user input data from a first user, such as an agent associated with an entity, where the user input data may indicate a selection of characteristics from a group of characteristics (e.g., “problem-solver,” “proactive,” “emotional intelligence,” “interpersonal communication skills,” etc.). For example, the agent may be associated with hiring operations (e.g., recruiter, human resources professional, etc.) of the entity. Accordingly, the entity may select characteristics based on characteristics and/or qualifications required by a particular job position. Based at least in part on the selection of the characteristics, the video analysis system may be configured to determine prompts from a group of prompts, where the prompts at least partially correspond to the characteristics. For example, the prompt may be configured to identify whether one or more users, such as job applicants, have personality traits associated with a problem-solver, proactivity, emotional intelligence, interpersonal communication skills, etc. Additionally, or alternatively, the video analysis system may be configured to send, display, and/or otherwise make the prompt available to applicants. For example, devices associated with the applicants may be communicatively coupled to the video analysis system via one or more networks and/or platforms.

The video analysis system may subsequently receive user input data from the applicants that are responsive to the prompts. In some examples, the user input data may include video data, audio data, and/or the like. For example, video data from the applicants may include video recordings of the applicants, and their responses to the prompts (e.g., a prompt asking to “describe how you would solve a conflict with a coworker”). Based on the video data associated with the applicants, the video analysis system may determine user characteristics (e.g., personality traits, attributes, and/or the like) associated with the applicants. For example, the video analysis system may be configured to identify one or more characteristics associated with each of the applicants based on their individual responses to the prompts. In some instances, the video analysis system may use, or work in combination with, a machine learning component, such that a machine learning model may be used to determine the user characteristics associated with the applicants.

Additionally, or alternatively, the video analysis system may be configured to determine a correlation between the user characteristics from the applicants and the characteristics indicated by the entity (e.g., whether the applicant is a problem-solver, proactive, has emotional intelligence, interpersonal communication skills, etc.). Based on the correlation, the video analysis system may determine a score associated with each of the applicants and/or their respective user characteristics. For example, the score may indicate the correlation between each individual user characteristic and each individual characteristic indicated by the entity. Additionally, or alternatively, the score may indicate an overall correlation for each applicant and the entity (e.g., the overall compatibility between a user and the entity). For example, scores above a particular threshold may indicate that the user characteristics for an applicant is correlated to the characteristics identified by the entity. Additionally, or alternatively, scores below a particular threshold may indicate that the user characteristics for an applicant is less closely correlated, and/or not correlated, to the characteristics identified the entity. The video analysis system may then be configured to transmit a representation of the score to the entity.

In some examples, the video analysis system may use, or work in combination with, a machine learning component, such that a machine learning model is used to determine scores associated with the applicants. In some instances, the entity may provide user input data indicating a prioritization, ranking, etc. associated with the characteristics. For example, the entity may provide user input data indicating that a characteristic is prioritized over another characteristic (e.g., prioritizing problem-solving over proactivity). Additionally, or alternatively, based on the prioritized characteristic, the video analysis system may be configured to weight the characteristics indicated by the entity and the characteristics associated with the applicants, where the weight may be used to determine the scores associated with the applicants. Additionally, or alternatively, the video analysis system may use, or work in combination with, a machine-learning component, such that a machine learning model is used to identify trends associated with the applicants and/or the user characteristics of applicants. For example, while the entity may provide user input data indicating characteristics from a group of characteristics (e.g., first characteristics) and/or prioritization of characteristics, the entity may identify user characteristics (e.g., second characteristics) associated with the applicants, but not correlated (e.g., a score below a threshold) to the first characteristics selected by the entity. For example, the video analysis system may identify a trend of second characteristics that are not correlated to the first characteristics, but are heavily prevalent amongst applicants based on the video data. Additionally, or alternatively, a machine learning model, such as generative artificial intelligence may use the trend of second characteristics amongst the applicants to generate and/or update the prompts made available to the applicants.

Once the video analysis system has determined scores associated with each of the users, the video analysis system may transmit score data indicating the scores to the entity. For example, the video analysis system may be configured to cause score data to be displayed at a user interface component of a device associated with the entity. In some examples, the video analysis system may cause other data to be displayed at the user interface component of the device associated with an agent of the entity. For example, similarly to the techniques described above, the video analysis system may generate text data from the video data of the applicants (e.g., a transcript of the responses to the prompts for each of the applicants). Additionally, or alternatively, the video analysis system may cause the text data to be displayed at the user interface component. This way, the entity may be able to view the one or more scores associated with each of the applicants, as well as a transcript of their responses, all while maintaining the anonymity of each of the applicants. For example, the video analysis system may be configured to apply one or more transformations to the user input data from applicants, user characteristics, text data, and/or score data in order to obscure and/or redact personally identifiable information (e.g., age, gender, race, ethnicity, disability, and/or the like) associated with the applicants. An agent of the entity may otherwise reveal the personally identifiable information if the video analysis system determines that the agent is an authorized user, a condition has been satisfied (e.g., score data indicating the scores to the entity have been transmitted, and applicants with scores below a threshold have been removed from consideration, etc.). The video analysis system may also be configured to perform similar analytics techniques as described above with respect to the text data (e.g., identify portions and/or segments, generate sentiment data, etc.).

In another example, the video analysis system may be configured to generate templates that are usable by the video analysis system in order to filter video data for further analysis and/or output. As described above, the video analysis system may be configured to filter aggregated user data (e.g., filter user data by one or more attributes from a group of attributes determined by the video analysis system). Additionally, or alternatively, a template may be generated and/or used by the video analysis system to filter and output user data based on particular insights, instructions, etc. For example, as described above, the video analysis system may receive user data, such as video data, from one or more users in response to a prompt (e.g., video data in response to an employee survey) and may further be configured to determine attributes associated with the users (e.g., demeanor, voice inflection, conduct, behavior, etc.). Additionally, or alternatively, the video analysis system may receive user data such as video data that is longer in duration, an aggregation of video data, etc. (e.g., video data corresponding to one or more employee meetings, daily briefings, a conference, etc.). The video analysis system may receive the user data periodically (e.g., every day, week, month, etc.) or continuously. In some instances, the video analysis system may be pushed user data, or be configured to pull the user data (e.g., pull from an entity system via API calls). Additionally, or alternatively, the video analysis system may receive the user data after one or more triggers. For example, the video analysis system may receive user data after a particular event (e.g., after an employee meeting takes place).

In some examples, the video analysis system may be configured to determine a template that is usable to gain insights associated with the user data. The template may be determined based on the user data (e.g., based on video data). For example, as described above, the video analysis system may determine attributes associated with users, video data included in user data, and/or the like. Attributes may indicate a demeanor, voice inflection, conduct, behavior, attitude, and/or the like. The template may be determined based on the attributes. By way of example, and not limitation, the video analysis system may receive user data corresponding to a company's daily briefings, such as video data capturing the contents of the daily briefings. The video analysis system may determine, based on the video data, one or more attributes associated with the video data and/or users associated with the video data. For example, the video analysis system may determine that the employees depicted in the video data and/or subject matter of the video data (e.g., employees engaging in daily briefings) are associated with attributes such as psychological insights (e.g., high empathy, risk-aversion, gratitude, agreeableness, etc.). As such, one or more templates may be based on the attributes associated with the employees depicted in the video data. By way of example, and not limitation, a template determined by the video analysis system may include an indication of the determined attributes associated with the video data, such as an indication of insights such as high empathy, risk-aversion, gratitude, and/or agreeableness. The template may be usable to receive user input (e.g., instructions) associated with an entity. For example, the video analysis system may receive, via the template, user input from an agent of the entity indicating one or more of the attributes indicated by the template. In some instances, the template may include an indication of a group of attributes, and user input may indicate a selection of one or more attributes of the group of attributes (e.g., the agent may select high empathy and risk-aversion, but not gratitude and agreeableness from an available list of psychological insights). Additionally, or alternatively, the template may be determined by the video analysis system independently from video data, and instead based on one or more attributes associated with an entity (e.g., based on business goals, company missions, etc.) and usable to gain insights associated with subsequent video data that is received by the video analysis system.

It is to be appreciated by a person of ordinary skill in the art that the video analysis system may determine one or more templates independently of user data (e.g., independently of attributes associated with video data). A template may include an indication of one or more general insights. By way of example, and not limitation, a template determined by the video analysis system may include an indication of one or more insights such as insightful spoken words and/or phrases, a flagship quote for a common area of issue, etc. The template may further be usable to receive user input (e.g., instructions) associated with an entity, where the user input may indicate a selection of one or more general insights (e.g., an agent of an entity may select insightful spoken words, but not a flagship quote).

Based on the user input, or instructions, the video analysis system may be configured to generate an output. An output may include an identification of one or more users, user videos, etc. associated with the user data (e.g., video portions). For example, user input received by the video analysis system, and responsive to one or more templates, may include instructions indicating one or more attributes, or insights, that are important to an entity. By way of example, and not limitation, the video analysis system may receive user input associated with an entity (e.g., hospital) and including instructions indicating that attributes such as high empathy and risk-aversion are important to the entity. Based on the instructions, the video analysis system may be configured to generate an output. In some instances, the output may include identifications of particular users (e.g., hospital employees engaged in a daily briefing as depicted in video data), particular quotes, a number of instances a particular topic was discussed, and/or the like. In some instances, and as described in more detail below, the output may be based on one or more portions of video data and/or related attributes. For example, the video analysis system may be configured to identify one or more portions of video data based on user instructions (e.g., instructions indicating particular attributes), and further analyze the one or more portions of video data to identify attributes associated with the one or more portions of video data (e.g., particular users, particular quotes, a number of instances a particular topic was discussed, etc.).

Continuing from the example above, user input may include instructions indicating the attributes of high empathy and risk-aversion. Based on the instructions, the video analysis system may identify one or more portions of video data. The video analysis system may also generate an output including an identification of one or more employees associated with the attributes of high empathy and/or risk-aversion. Additionally, or alternatively, based on the instructions, the video analysis system may generate an output including an identification of one or more quotes and/or spoken words during the daily briefing and associated with the attributes of high empathy and risk-aversion. In some instances, the video analysis system may be configured to generate an output based on attributes not indicated in instructions. By way of example, and not limitation, the video analysis system may be configured to identify particular users, quotes, and/or the number of instances a particular topic was discussed based on other attributes not indicated in instruction. For example, the video analysis system may identify a common (e.g., high-frequency) attribute associated with video data, where the attribute is not indicated by the instructions. As such, the output may include an indication of the high-frequency attribute such that it is brought to the attention of an entity. Further, the video analysis system may be configured to identify one or more portions of video data and associated high-frequency attributes that are not indicated by the instructions. Additionally, or alternatively, as described above, user input may include instructions indicating general insights. In instances where user input includes instructions indicating general insights, the video analysis system may generate an output, using the techniques described herein, to identify one or more portions of video data including attributes such as high-frequency words, phrases, emotions, etc.

In some instances, the video analysis system may be configured to generate a representation associated with the output. Continuing from the example above, the video analysis system may be configured to generate an output including an identification of particular users (e.g., one or more employees), particular quotes, a number of instances a particular topic was discussed, etc. associated with particular attributes (e.g., high empathy and risk-aversion). Based on the output, the video analysis system may generate a representation indicating the particular users, particular quotes, number of instances a particular topic was discussed, etc. By way of example, and not limitation, a representation may include a graphic (image, video, and/or the like) of an employee associated with attributes of high empathy and risk-aversion. In some instances, the representation may include a graphic depicting the employee at a time at which the employee exhibited the attributes of high empathy and risk-aversion (e.g., portions of video data). Additionally, or alternatively, a representation may include an indication of particular quotes associated with the attributes of high empathy and risk-aversion (e.g., quotes spoken by employees during a daily briefing) and/or the employee that said such quote.

Additionally, or alternatively, as described above, user input may include instructions indicating general insights, where the video analysis system may generate an output identifying insights such as common words, phrases, emotions, etc. In instances where the user input includes instructions indicating general insights, the video analysis system may output insights such as high-frequency attributes, low-frequency attributes, and/or the like. Accordingly, a representation may include an indication of the insights (e.g., a ranking of attributes, such as emotions, as a function of frequency). Additionally, or alternatively, based on an output, a representation may include an indication of insights as a function of time. By way of example, and not limitation, user data may include video data collected over a period of one year. Based on the video data, the video analysis system may determine changes in attributes of the period of one year (e.g., attributes of employees participating in daily briefings and depicted in video data). A representation may include an indication of the average, or common, attribute of employees for each month over the period of one year.

In some instances, the representations generated by the video analysis system may be configured to elicit further user input. For example, the video analysis system may be configured to cause one or more representations to be displayed at a user interface device. Further, the video analysis system may be configured to generate representations that may be usable to receive further user input at the user interface (e.g., representations including selectable, movable, etc. user interface components). By way of example, and not limitation, a representation may include user interface components associated with high-frequency attributes, such as emotions, where user input may be received via a user interface component in order to organize, or rank, the frequency attributes (e.g., an agent of a hospital may use the representation to rank the frequency of certain emotions amongst hospital staff). In another example, a representation may include interface components associated with a particular quote, where user input may be received via a user interface component in order to identify a particular user associated with the quote (e.g., an agent of a hospital may use the representation to identify, or guess, the hospital employee who said the particular quote).

The techniques described herein improve the function of video analysis and processing. For example, in order to gain insights with respect to an entity, product, service, etc., an entity must use surveys which may be impersonal, inflexible, and resource-intensive. Traditional surveys typically include a limited amount of information, as well as little information about the employees, consumers, etc. responding to a survey. Further, traditional surveys may elicit large amounts of information that may be onerous to process, as well as may omit frequent and/or insightful input from employees, consumers, etc. that may not be elicited by limited surveys. Accordingly, the techniques described herein increase efficiencies around the processing of video data and thus enable entities to obtain insights from large amounts of video data. Additionally, the techniques may also improve the utilization of computing resources, such as processing power and storage. For example, the techniques described herein enable video data received by the video analysis system to be filtered, with smaller portions of the video data being processed and/or stored. Additionally, the techniques described herein enable the video analysis system to process video data, with smaller quantities of characteristics, prompts, and/or the like being processed and/or stored.

These and other aspects are described further below with reference to the accompanying drawings. The drawings are merely example implementations and should not be construed to limit the scope of the claims. For example, while examples are illustrated in the context of a user interface for a mobile device, the techniques may be implemented using any computing device and the user interface may be adapted to the size, shape, and configuration of the particular computing device.

Some of the techniques described herein are with reference to the receipt and processing of video data. However, the techniques are generally applicable to any type of data. Additionally, or alternatively, the techniques described herein are with reference to video data. However, the techniques are generally applicable to any environment, platform, etc.

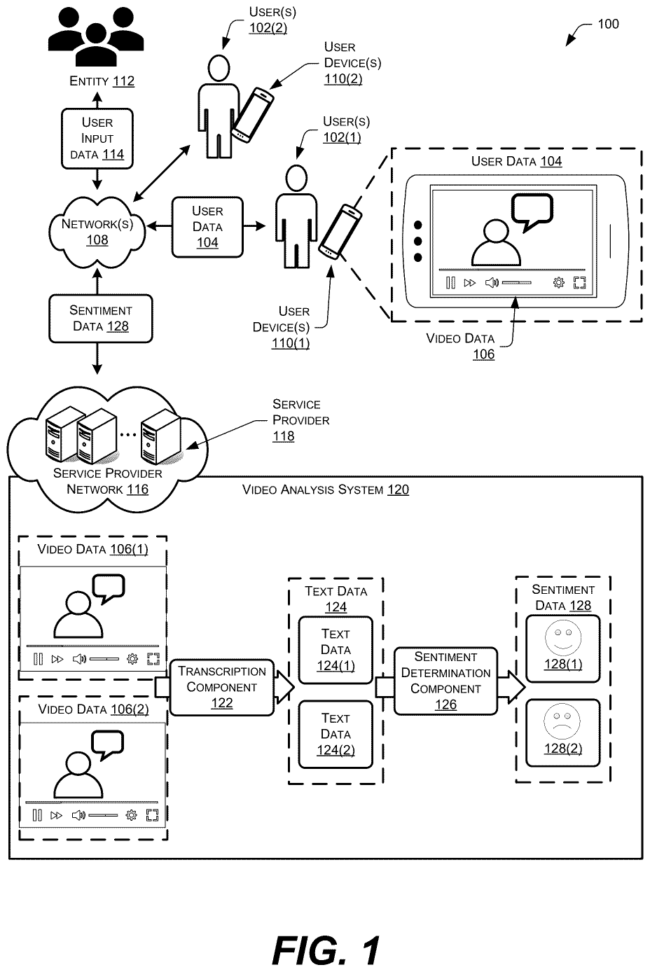

FIG. 1 is a schematic view 100 of an example system 120 usable to analyze user videos and generate sentiment data 128 associated with a user 102 and/or entity 112, according to at least some examples.

A user of a video analysis system 120 may include an individual user, business, corporation, entity, enterprise, and/or the like. For example, the entity 112 may use the video analysis system 120 in order to gain insights via video data 106 for products and/or services associated with the entity 112. For example, the entity 112 may provide user input data 114 to the video analysis system 120, which may indicate a request for video data 106 from one or more users 102. Additionally, or alternatively, the video analysis system 120 may receive user data 104 from the one or more users 102, which may include video data, audio data, and/or the like. In some examples, the video data 106 may include a video recorded by the user 102, a video depicting the user 102 and/or the user speaking, a video of the environment of the user 102 and/or the user speaking, etc. As illustrated, users 102 may be associated with user device(s) 110 that enables the user 102 to share user data 104 with the video analysis system 120. In some examples, the user device(s) 110 may include desktop computers, laptop computers, tablet computers, mobile devices (e.g., smart phones or other cellular or mobile phones, mobile gaming devices, portable media devices, devices for mass-audience broadcasting and streaming, etc.), or other suitable computing devices. The user device(s) 110 may execute one or more client applications, such as a web browser (e.g., Microsoft Windows Internet Explorer, Mozilla Firefox, Apple Safari, Google Chrome, Opera, etc.) and/or a native or special-purpose client application (e.g., social media applications, messaging applications, email applications, games, etc.), to access and view content over the network 108.

In some examples, the service provider network 116 may be or comprise a cloud provider network associated with a service provider 118. In other instances, however, the service provider network 116 may be an on-premises network, a private network of a corporation, and/or any other type of network or combination thereof. The video analysis system 120 may be included in, or associated with, the service provider network 116. The video analysis system 120 may provide video analytics, such as sentiment data 128, to user(s) 102 at user device(s) 110. User device(s) 110 may communicate with the service provider 118 over network(s) 108, such as Internet. In some instances, the network(s) 108 may generally comprise one or more networks implemented by any viable communication technology, such as wired and/or wireless modalities and/or technologies. The network(s) 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the user device(s) 110 and/or third-party entities may access the video analysis system 120.

In some examples, the video data 106 from the one or more users 102 may be provided to the video analysis system 120 in response a prompt. In some examples, the video data 106 from the one or more users 102 may be provided to the video analysis system 120 unprompted. Additionally, or alternatively, the video analysis system 120 may be configured to receive user data 104, and in turn, video data 106, from multiple users 102, and aggregate the video data 106. For example, user 102(1) may be associated with video data 106(1). Additionally, or alternatively, user 102(2) may be associated with video data 106(2), where video data 106(1) and 106(2) are aggregated at the video analysis system 120. In instances where the video analysis system 120 receives user data 104 from multiple users 102, the user data 104 and/or video data 106 may be aggregated and/or stored collectively such that the user data 104 is accessible to the entity 112. For example, the video data 106 may be accessible via a user interface associated with the video analysis system 120.

In some examples, the video analysis system 120 may be configured to apply one or more transformations to the aggregated video data 106 in order to generate text data 124. For example, the video analysis system may use, or work in combination with, a transcription component 122 to generate text data 124. The text data 124 may represent the content of a video associated with the video data 106. For example, text data 124(1) may represent the content of a video associated with video data 106(1), and text data 124(2) may represent the content of a video associated with video data 106(2). In some examples, the text data 124 may represent user utterances, phrases, and/or otherwise transcribe the content of the video to generate the text data 124. Additionally, or alternatively, the video analysis system 120 may be configured to determine attributes associated with the video data 106. In some examples, the attributes may include attributes of the user associated with the video data 106. For example, the attributes may indicate a demeanor, voice inflection, conduct, behavior, attitude, and/or the like of a user included in the video. Additionally, or alternatively, the attributes may include attributes of the content of the video data 106. For example, the attributes may indicate positive language (e.g., a user in the video saying “I love this commercial”), negative language (e.g., a user in the video saying “I really did not like how long this commercial was”), and/or the like. In some instances, the attributes may be determined using a machine learning model that is trained to determine attributes based on text data, video data 106, and/or the like.

Based on the attributes, the video analysis system 120 may determine sentiments and generate sentiment data 128. The video analysis system 120 may use, or work in combination with, a sentiment determination component 126 to determine sentiments and generate sentiment data 128. The sentiments may be associated with the entity 112 and/or the users 102. For example, sentiments associated with the entity 112 may include a user value, feeling, perspective, etc. associated with a brand, entity 112, etc. In some instances, sentiments may include any information that may be usable by a brand and/or entity 112 to gain user (e.g., consumer) insights. Sentiments may be determined by the video analysis system 120 on a per-user and/or per-video basis (e.g., for each user data 104 and associated video data 106). As illustrated, sentiment data 128(1) may correspond to video data 104(1), and may indicate that the user 102(1) has a positive sentiment associated with the entity 112. Sentiment data 128(2) may correspond to video data 104(2), and may indicate that the user 102(2) has a negative sentiment associated with the entity 112. Although not illustrated, the sentiments may be determined by the video analysis system 120 for the entire aggregation of video data 106 (e.g., sentiments representing the content included in all user videos). For example, in instances where user data 104 has been received from multiple users 102, a sentiment data 128(1) associated with user 102(1) and based on video data 106(1) may be determined, and sentiment data 128(2) associated with the user 102(2) and based on video 106(2) may be determined. The video analysis system 120 may generate sentiment data 128 taking into account both sentiment data 128(1) and/or sentiment data 128(2), where the sentiment data 128 indicates an overall sentiment associated with the entity 112 and from the users 102. Additionally, or alternatively, sentiment data 128 may be provided to the entity 112. For example, the video analysis system 120 may be configured to generate a representation including the aggregation of user data 104 (e.g., an aggregation of video data 106), an indication of the sentiment data 128, the text data 124, and/or the like. The representation may further be displayed at a user interface associated with the video analysis system 120 and accessible by the entity 112.

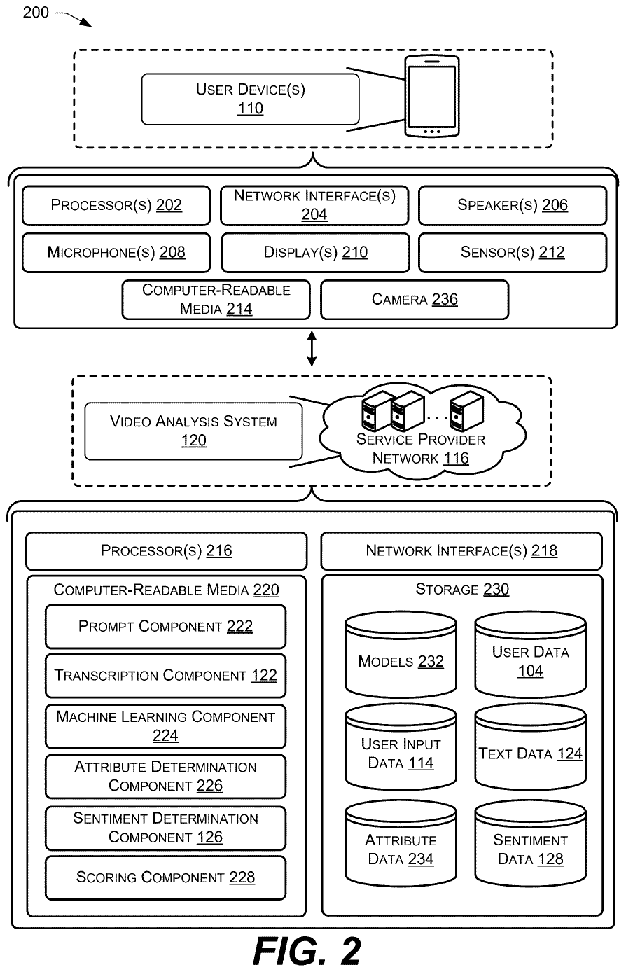

FIG. 2 illustrates example components of a user device 110 and the components of the video analysis system 120 at the service provider network 116. The user device 110 and/or the video analysis system 120 may include one or more hardware processor(s) 202 and/or 216 (processors) configured to execute one or more stored instructions. The processors 202 and/or 216 may comprise one or more cores.

Further, the user device 110 and/or the video analysis system 120 may include network interface(s) 204 and/or 218 to allow the processor 202 and/or 216 or other portions of the service provider network 116 and/or device 110 to communicate with other devices. The network interface(s) 204 and/or 218 may comprise Inter-Integrated Circuit (I2C), Serial Peripheral Interface bus (SPI), Universal Serial Bus (USB) as promulgated by the USB Implementers Forum, RS-232, and so forth. The network interface(s) 204 and/or 218 may include devices configured to couple to personal area networks (PANs), wired and wireless local area networks (LANs), wired and wireless wide area networks (WANs), and so forth. For example, the network interface(s) 204 and/or 218 may include devices compatible with Ethernet, Wi-Fi™, and so forth. Network interfaces 204 and/or 218 are representative of functionality to allow a user to enter commands and information to the user device 110 and/or the video analysis system 120, and also allow information to be presented to the user and/or other components or devices using various input/output devices. For example, user device 110 may include input devices such as speakers 206, microphones 208, displays 210, sensors 212, and/or camera 236 (e.g., which may employ visible or non-visible wavelengths such as infrared frequencies to recognize movement as gestures that do not involve touch). Examples of input devices include a keyboard, a cursor control device (e.g., a mouse), a scanner, touch functionality (e.g., capacitive or other sensors that are configured to detect physical touch), and so forth. Examples of output devices include a display device (e.g., a monitor or projector), speakers, a printer, a network card, tactile-response device, and so forth.

The user device 110 and/or the video analysis system 120 may also include computer-readable media 214 and/or 220 that stores various executable components (e.g., software-based components, firmware-based components, etc.). In addition to various components discussed in FIG. 1, the computer-readable media 214 and/or 220 may further store components to implement functionality described herein. While not illustrated, the computer-readable media 214 and/or 220 may store one or more operating systems utilized to control the operation of the one or more devices that comprise the service provider network 116. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media 220 may include a prompt component 222 that configures the video analysis system 120 to perform various operations described herein. For instance, the prompt component 222 may be configured to, when executed by the processors 216, perform various techniques for determining and/or generating prompts. For example, the prompt component 222 may utilize data, such as user input data 114 to determine prompts to be provided to users in order to receive user data 104, such as video data.

The computer-readable media 220 may include a transcription component 122 that configures the video analysis system 120 to perform various operations described herein. For instance, the transcription component 122 may be configured to, when executed by the processors 216, perform various techniques for transcribing user data 104 in order to generate text data 124.

The computer-readable media 220 may include a machine learning component 224 that configures the video analysis system 120 to perform various operations described herein. For instance, the machine learning component 224 may be configured to, when executed by the processors 216, perform various techniques such as predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

The computer-readable media 220 may include an attribute determination component 226 that configures the video analysis system 120 to perform various operations described herein. For instance, the attribute determination component may be configured to, when executed by the processors 216, perform various techniques such determining attributes associated with user data 104, such as video data in order to generate attribute data 234.

The computer-readable media 220 may include a sentiment determination component 126 that configures the video analysis system 120 to perform various operations described herein. For instance, the sentiment determination component 126 may be configured to, when executed by the processors 216, perform various techniques such as determining user sentiments (e.g., sentiment data 128) associated with an entity.

The computer-readable media 220 may include a scoring component 228 that configures the video analysis system 120 to perform various operations described herein. For instance, the scoring component 228 may be configured to, when executed by the processors 216, perform various techniques such as determining scores associated with one or more users based on user data 104 (e.g., video data), and based on characteristics associated with the users and characteristics included in user input data 114 from an entity.

Additionally, the video analysis system 120 may include storage 230 which may comprise one, or multiple, repositories or other storage locations for persistently storing and managing collections of data such as databases, simple files, binary, and/or any other data. The storage 230 may include one or more storage locations that may be managed by one or more storage/database management systems. The storage 230 represents memory/storage capacity associated with one or more computer-readable media 220. The storage 230 may include volatile media (such as random access memory (RAM)) and/or nonvolatile media (such as read only memory (ROM), Flash memory, optical disks, magnetic disks, and so forth). The storage 230 may include fixed media (e.g., RAM, ROM, a fixed hard drive, and so on) as well as removable media (e.g., Flash memory, a removable hard drive, an optical disc, and so forth).

As illustrated, the storage 230 may include models 232, user data 104, user input data 114, text data 124, attribute data 234, and/or sentiment data 128. It should be appreciated that the foregoing list is merely exemplary and the storage 230 may include additional elements that may be apparent to one skilled in the art.

The models 232 may include a database of machine learning models that are to be used by the machine learning component 224. The user data 104 may include a database of user videos and/or other media provided by one or more users. The user input data 114 may include a database of data provided by entities, such as a request for prompt generation by the video analysis system 120, information types, characteristics for determining a user score, and/or the like. The text data 124 may include a database of text data 124 representing the content of videos associated with the video data of user data 104. Attribute data 234 may include a database of attribute data 234 determined by the attribute determination component 226, such as attributes associated with video data of the user data 104. Sentiment data 128 may include a database of sentiment data 128 determined by the sentiment determination component 126, such as a user's sentiment toward an entity, an overall sentiment across multiple users toward an entity, and/or the like.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

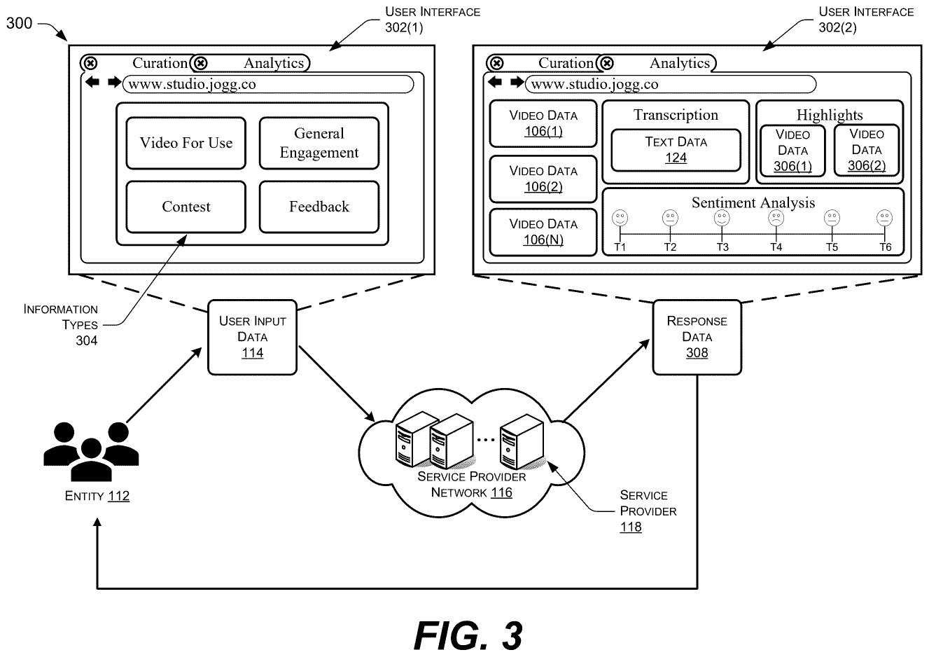

FIG. 3 illustrates an example process 300 and related user interfaces 302 for the generation of video prompts and the display of response data 308 associated with user videos, according to at least some examples.

A video analysis system, such as video analysis system 200 associated with service provider 118, may be configured to generate and/or use prompts in the analysis of video data 106. This way, an entity 112 and/or the video analysis system may elicit particular information in the user data (e.g., particular content associated with video data 106). For example, the video analysis system may receive user input data 114 from an entity 112, where the user input data 114 may include a request from the entity 112. For example, the request may include a request to receive particular user feedback and/or response data 308.

Additionally, or alternatively, the user input data 114 may include an indication of a prompt and/or a request for the video analysis system to generate a prompt. For example, the request may include an indication of information types 304, where the entity 112 would receive particular user feedback and/or response data 308 for the information types 304. An information type 304 may include an indication of a purpose associated with the entity 112 (e.g., general engagement, contest, video for use, feedback, and/or the like). As illustrated, the video analysis system may be associated with a user interface 302(1), at which the entity 112 (e.g., an agent of the entity 112) may provide user input data 114 indicating the information types 304. The user input data 114 and information types 304 may then be provided to the video analysis system via service provider network 116. Additionally, or alternatively, the video analysis system may be configured to identify information types 304 based on the request and/or user input data 114. Further, based on the information types 304 and/or the user input data 114, the video analysis system may determine a prompt, which may be sent to one or more users (e.g., individuals, consumers, etc.). By way of example, and not limitation, based on user input data 114 including an information type 304 indicating a purpose of general engagement, the video analysis system may be configured to determine a prompt to be sent to the one or more users, such that the video analysis system may receive video data 106 from the one or more users associated with general engagement. For example, video data 106(1), 124(2) and 124(3) may each be associated with general engagement, and thus included in the response data 308 and represented at the user interface 302(2), which may be accessible by the entity 112 via service provider network 116.

Additionally, or alternatively, the video analysis system may be configured to use an information type 304 and/or prompt to remove video data 106 from a particular user. Response data 308 may include video data 106(1), 124(2), and/or 124(N) (where “N” is any integer greater than zero). Video data 106 may also be represented at user interface 302(2). For example, the information type 304 and/or prompt may indicate a purpose associated with the entity 112 to receive feedback regarding a football movie. Accordingly, the video analysis system may receive video data 106 from one or more users in response to the prompt. In some examples, the video analysis system may determine a correlation between the video data 106 and the prompt and/or information type 304. For example, video data 106(1) may indicate a video in which a first user is talking about the football movie. Additionally, or alternatively, video data 106(2) may indicate a video in which a second user only discusses the weather. The video analysis system may determine that the video data 106(1) has a first correlation value (e.g., 10 on a scale of 1-10), and may determine that the video data 106(2) has a second correlation value (e.g., 1 on a scale of 1-10.) The video analysis system may further determine that the first correlation value does not violate a threshold correlation value (e.g., a threshold of 5 on the scale of 1-10), and may determine that the second correlation value violates the threshold correlation value. Accordingly, the video analysis system may remove video data 106(2) such that it is not included in the response data 308 and/or the user interface 302(2).

Additionally, or alternatively, the video analysis system may receive user data, and thus video data 106, from one or more users in response to a prompt, and may further be configured to determine attributes associated with the users and/or the video data 106. The attributes may indicate a demeanor, voice inflection, conduct, behavior, attitude, and/or the like of a user included in the video. Additionally, or alternatively, the attributes may include attributes of the content of the video data 106. In some instances, the video analysis system may be configured to determine attributes based at least in part on the information types 304 included in, and/or identified from, the request and/or user input data 114 of the entity 112. By way of example, and not limitation, based on user input data 114 including an information type 304 indicating a purpose of general engagement, the video analysis system may be configured to determine attributes that correspond to general engagement. Additionally, or alternatively, based on the attributes determined by the video analysis system, the video analysis system may further be configured to generate response data 308 for the entity 112. For example, response data 308 may include an indication of the attributes, sentiments determined based on the attributes, analytics, feedback, insights, etc. associated with the video data 106 received by the video analysis system. The response data 308 may include video data 106 (e.g., video data 106 from multiple users), text data 124 representing the content of the video data 106, different portions of video data 106, sentiment data, and/or the like. For example, the text data 124 may represent the content of videos associated with video data 106. Additionally, or alternatively, the user interface 302(2) may be configured to further receive user input data 114 from the entity 112 (e.g., agents of the entity 112) indicating a selection of a portion of the text data 124. In other words, the agent may otherwise “highlight” a portion of the text data 124. For example, an agent of the entity 112 may highlight a portion of the text data 124 based on the portion being of particular importance to the agent and/or entity 112. For example, the agent may highlight a first portion and a second portion of the text data 124. Accordingly, the video analysis system may update the response data 308 and/or user interface 302(2) to include an indication of the selected portion of the text data 124. For example, the video analysis system may include an indication of video data 306(1) that corresponds to the first portion of the text data 124, and video data 306(2) that corresponds to the second portion of the text data 124.

As described above with respect to FIG. 1, sentiments may be determined based on attributes associated with video data 106. Additionally, or alternatively, the video analysis system may be configured to determine sentiments associated with video data 106 as a function of time. For example, attributes associated with particular video data 106, such as video data 106(1) may indicate a positive sentiment at a first instance of the video data 106(1), and a negative sentiment at a second instance of the video data 106(1). As part of this, the video analysis system may be configured to correlate individual times associated with the video data 106(1) with individual sentiments, as illustrated at user interface 302(2) and included with response data 308.

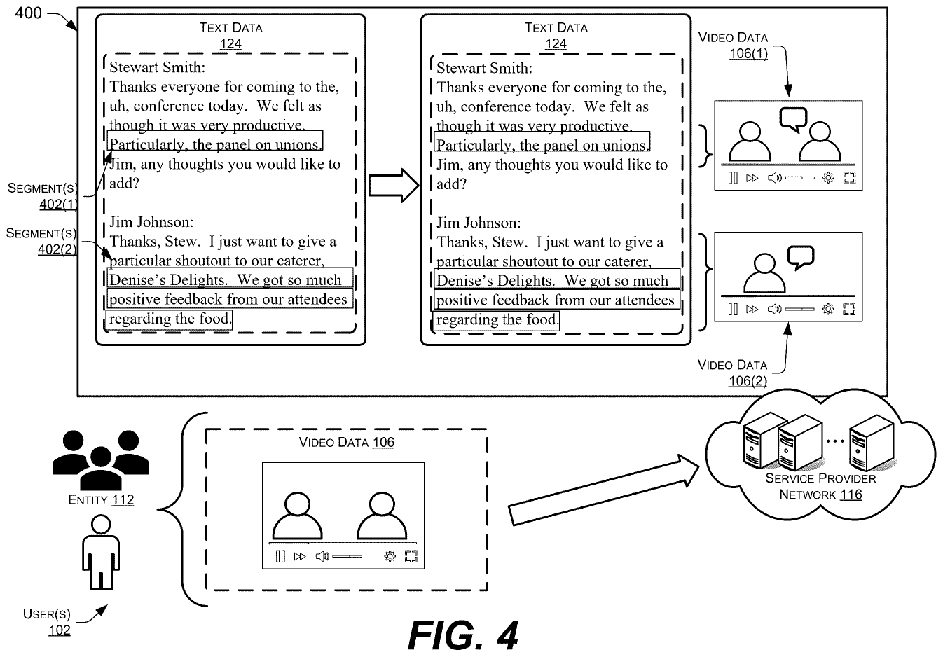

FIG. 4 illustrates an example process 400 for further processing of user videos, according to at least some examples.

In some examples, a video analysis system, such as video analysis system 120 of FIG. 1, may be configured to further process video data 106 and/or moderate content between multiple users 102. For example, the video analysis system may receive user data 104 via a service provider network 116, which may include video data 106, from an entity 112 and/or user 102. In some instances, the video data 106 may be longer in duration (e.g., associated with a video representing the content of a week-long conference). Additionally, the entity 112 may be associated with the content of the video included in the video data 106 (e.g., an administrator of the conference, and/or the like). In some examples, the video data 106 may be accessible by users 102 via a content moderation platform associated with the video analysis system.

As described above, the video analysis system may apply one or more transformations to the video data 106 to generate text data 124 representing the video data 106 (e.g., a transcription of the content of the video associated with the video data 106). Based on the text data 124, information types associated with the content of the video data 106 may be determined. For example, information types may include a particular portions of the text data 124 pertaining to a particular topic. Further, the video analysis system may receive user 102 input data from the entity 112, or from one or more additional users 102, which may include an indication of a particular information type from the information types. For example, the user 102 input data may include a “search” from the first user 102 and/or the second user 102 (e.g., a search for a particular word, phrase, etc.), an indication of a particular portion of the text data 124 (e.g., a user 102 “highlight” of the text data 124), and/or the like.

Additionally, or alternatively, segments 402 of the text data 124 that are associated with the particular information type may be determined and/or identified. For example, the video analysis system may identify a first segment 402(1) of text data 124 (e.g., for a transcription of a week-long conference), where the first segment 402(1) is associated with an information type such as a particular panel provided at the conference. Additionally, or alternatively, the video analysis system may identify a second segment 402(2) of the text data 124, where the second segment 402(2) is associated with an information type such as the catering of the conference. The video analysis system may also be configured to correlate, or otherwise identify, video data 106 that is represented by the segments 402 (e.g., the portion of the video data 106 that corresponds to text data 124 included in the segments 402). For example, the video analysis system may determine that a portion of the video data 106, or video data 106(1), corresponds to segment 402(1). Additionally, or alternatively, the video analysis system may determine that a portion of the video data 106, or video data 106(2), corresponds to segment 402(2). The video analysis system may also be configured to store a representation of the video data 106 that is represented by the segments 402. This way, the entity 112 may be able to access particular portions of the full-length video data 106 easily and quickly. Additionally, or alternatively, as described above, the entity 112 may enable users 102 to access the video data 106. Similarly, one or more additional users 102 may be able to provide user 102 input data indicating a particular information type, where segments 402 of the text data 124 that are associated with the particular information type may be determined and/or identified. In some examples, the video analysis system may be configured to identify additional segments 402 of text data 124 associated with a particular information type. By way of example, and not limitation, in instances where the first segment 402(1) of text data 124 is associated with video content such as a particular panel provided at a conference, the video analysis system may identify additional segments 402 of text data 124 associated with the particular panel provided at the conference, and store a representation of both the first segment 402(1) of text data 124 and the additional segments 402 of text data 124.

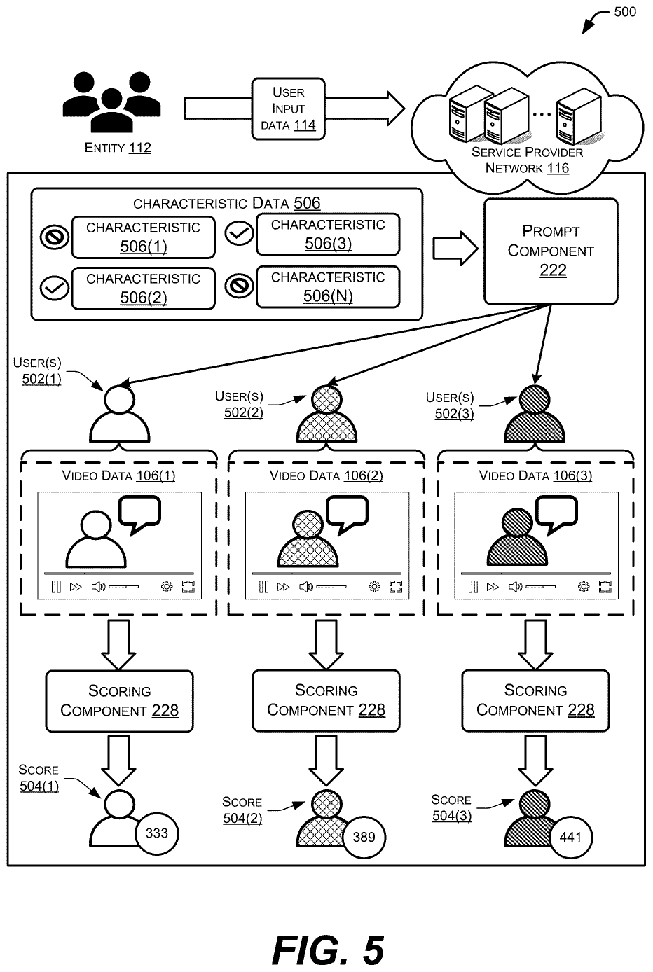

FIG. 5 illustrates an example process 500 for score determinations of users, according to at least some examples.

A video analysis system, such as video analysis system 120, may be configured to determine attributes of users 502 (e.g., applicants) associated with video data 106, and determine a score 504 associated with the users 502. For example, the video analysis system may receive user input data 114 from an entity 112, such as an agent of entity 112, where the user input data 114 may indicate a selection of characteristics, such as characteristics 506(1), 506(2), 506(3), and/or 506(N) (where “N” is any integer greater than zero) from a group of characteristics 506 (e.g., “problem-solver,” “proactive,” “emotional intelligence,” “interpersonal communication skills,” etc.). For example, an agent of entity 112 may be associated with hiring operations (e.g., recruiter, human resources professional, etc.) of the entity 112. Accordingly, the entity 112, and/or the agent on behalf of the entity 112, may select characteristics 506(1), 506(2), 506(3), and/or 506(N) based on characteristics and/or qualifications required by a particular job position. For example, as illustrated, entity 112 may select characteristics 506(2) and 506(3), but not 506(1) and/or 506(N). Based at least in part on the selection of the characteristics, the video analysis system may be configured to determine prompts from a group of prompts, where the prompts at least partially correspond to the characteristics. In some examples, the video analysis system may use, or work in combination with, prompt component 222 to determine prompts. For example, the prompt may be associated with skills associated with characteristic 506(2) and 506(3). Additionally, or alternatively, the video analysis system may use, or work in combination with, prompt component 222 to update prompts made available to users 502 based on a trend associated with the users 502. For example, trends may indicate the users 502 each being associated with characteristic 506(1), which may not be selected by the entity 112. Accordingly, the prompt component 222 may update the prompts made available to users 502 based on the trend. Additionally, or alternatively, the video analysis system may be configured to send, display, and/or otherwise make the prompt available to one or more users 502. For example, devices associated with one or more users 502 may be communicatively coupled to the video analysis system.

The video analysis system may subsequently receive user from the users 502 that are responsive to the prompts. In some examples, the user data may include video data 106, audio data, and/or the like. For example, video data 106 from the users 502 may include video recordings of the users 502, and their responses to the prompts (e.g., a prompt asking the users 502 to “describe how you would solve a conflict with a coworker”). Based on the video data 106 associated with the users 502, may be configured to identify one or more characteristics associated with each of the users 502 based on their individual responses to the prompts. Additionally, or alternatively, the video analysis system may be configured to determine a correlation between the user characteristics from the users 502 and the characteristics 506 indicated by the entity 112 (e.g., whether the user has characteristic 506(2) and/or 506(3). Based on the correlation, the video analysis system may determine a score 504 associated with each of the users 502 and/or their respective characteristics. In some instances, the video analysis component may use, or work in combination with, a scoring component 228 to determine scores 504 associated with the users 502. For example, the score 504 may indicate the correlation for reach respective user characteristics and the characteristics 506 indicated by the entity 112. For example, based on video data 106(1), it may be determined that the user 502(1) has characteristic 506(1). Additionally, or alternatively, based on video data 106(2), it may be determined that the user 502(2) has characteristic 506(3). Additionally, or alternatively, based on video data 106(3), it may be determined that the user 502(3) has characteristic 506(2) and 506(3). Accordingly, as illustrated, the user 502(3) may be given the highest score (e.g., 441 on a scale of 1-500).

Additionally, or alternatively, the score 504 may indicate an overall correlation for each user 502 and the entity 112 (e.g., the overall compatibility between users 502 and the entity 112). For example, scores 504 above a particular threshold may indicate that the characteristics for the users 502 are more closely correlated to the characteristics 506 selected by the entity 112. By way of example, and not limitation, scores 504 below a threshold of 400 (e.g., score 504(1) and 504(2)) may indicate that the characteristics of the users 502(1) and 502(2) are less closely correlated to the characteristics 506 selected by the entity 112. Scores 504 above a threshold of 400 (e.g., score 504(3)) may indicate that the characteristics of users 502(3) are more closely correlated to the characteristics 506 selected by the entity 112. The video analysis system may then be configured to transmit a representation of the scores 504 to the entity 112.

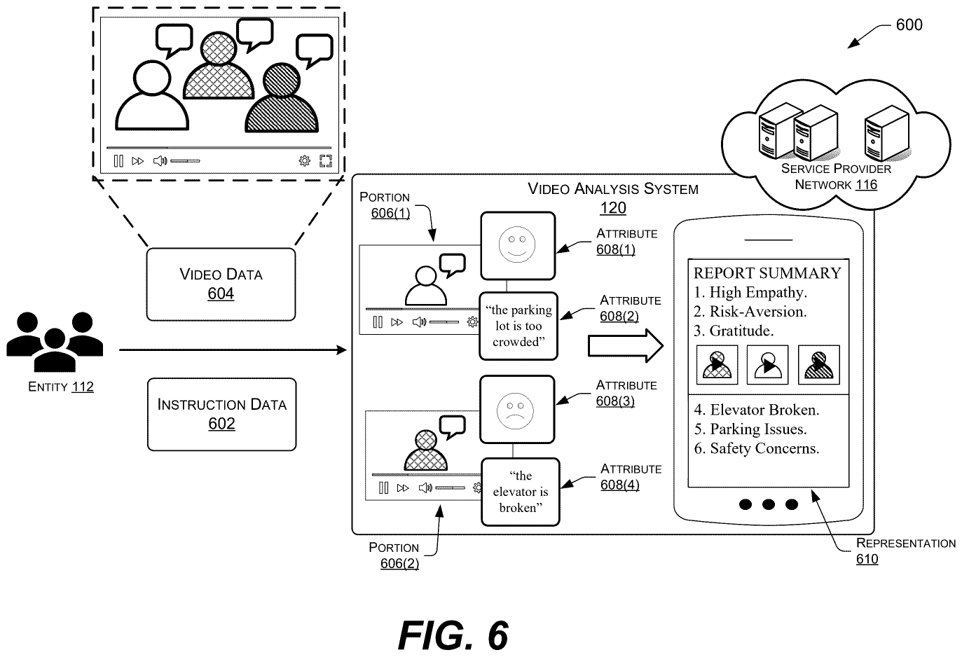

FIG. 6 illustrates an example process 600 for filtering user videos for analysis and subsequent output, accordingly to at least some examples.

As illustrated, the video analysis system 120 may be configured to filter aggregated user data (e.g., filter video data 604 by one or more attributes from a group of attributes 608 determined by the video analysis system 120). Additionally, or alternatively, a template may be generated and/or used by the video analysis system 120 to filter and output user data based on particular insights, instructions, etc. (e.g., instruction data 602) For example, as described above, the video analysis system 120 may receive user data, such as video data 604, from one or more users in response to a prompt (e.g., video data in response to an employee survey). In some examples, the video data 106 may include a video recorded by one or more users, a video depicting one or more users, and/or the one or more users speaking, a video of a particular environment and/or event, etc. Additionally, or alternatively, the video analysis system 120 may receive video data 604 that is longer in duration, an aggregation of video data, etc. (e.g., video data corresponding to one or more employee meetings, daily briefings, a conference, etc.). In some examples, an entity (business, corporation, enterprise, organization, etc.) 112 may provide video data 604 to the video analysis system 120.

The video analysis system 120 may receive the video data periodically (e.g., every day, week, month, etc.) or continuously. In some instances, the video analysis system 120 may be pushed video data 604, or be configured to pull the video data 604 (e.g., pull from an entity system via API calls). Additionally, or alternatively, the video analysis system 120 may receive the video data 604 after one or more triggers. For example, the video analysis system 120 may receive video data 604 after a particular event (e.g., after an employee meeting takes place).

As described in more detail below with respect to FIG, 7, the video analysis system 120 may be configured to determine a template that is usable to gain insights associated with the video data 604. The template may be determined based on the video data 604. For example, as described above, the video analysis system 120 may determine attributes 608 associated with users, video content, etc. associated with the video data 604. By way of example, and not limitation, attributes may indicate a demeanor, voice inflection, conduct, behavior, attitude, and/or the like. The template may be determined based on the attributes. By way of example, and not limitation, the video analysis system 120 may receive video data 604 corresponding to a company's (e.g., entity 112) daily briefings. The video analysis system 120 may determine, based on the video data 604, one or more attributes 608 associated with the video data 604 and/or users associated with the video data 604. For example, the video analysis system 120 may determine that the employees depicted in the video data 604 and/or subject matter of the video data 604 (e.g., employees engaging in daily briefings) are associated with attributes 608 such as psychological insights (e.g., high empathy, risk-aversion, gratitude, agreeableness, etc.). As such, one or more templates may be based on the attributes 608 associated with the employees depicted in the video data 604. By way of example, and not limitation, a template determined by the video analysis system 120 may include an indication of the determined attributes 608 associated with the video data 604, such as an indication of insights such as high empathy, risk-aversion, gratitude, and/or agreeableness. The template may be usable to receive user input (e.g., instruction data 602) associated with entity 112. For example, the video analysis system 120 may receive, via the template, instruction data 602 from an agent of the entity 112 indicating one or more of the attributes 608 indicated by the template.

Based on the instruction data 602, the video analysis system 120 may be configured to generate an output. An output may include an identification of one or more users, user videos, etc. associated with the video data 604 (e.g., video portions 606). For example, instruction data 602 received by the video analysis system 120, and responsive to one or more templates, may indicate attributes 608 that are important to the entity 112. By way of example, and not limitation, the video analysis system 120 may receive user input associated with an entity (e.g., hospital) and including instructions indicating that attributes such as high empathy and risk-aversion are important to the entity. Based on the instructions, the video analysis system 120 may be configured to generate an output. For example, based on the instructions and attribute 608(1) (e.g., high empahty and risk-aversion), the video analysis system 120 may identify a portion 606(1) of the video data 604, where the portion 606(1) is associated with an indication an employee associated with the attribute 608(1). In some instances, the video analysis system 120 may be configured to generate an output based on attributes not indicated in instructions. By way of example, and not limitation, the video analysis system 120 may be configured to identify particular users, quotes, and/or the number of instances a particular topic was discussed based on other attributes not indicated in instruction data 602. The video analysis system 120 may identify a common (e.g., high-frequency) attribute associated with video data 604, where the attribute is not indicated by the instruction data 602. By way of example, and not limitation, the video analysis system 120 may identify attribute 608(2) associated with the portion 606(1), where the attribute 608(2) indicates a high-frequency quote that users (e.g., employees) from multiple portions 606 of the video data 604 are saying (e.g., that “the parking lot is too crowded”). As such, the output may include an indication of the high-frequency attribute such that it is brought to the attention of the entity 112. Additionally, or alternatively, as described above, instruction data 602 may include general insights. Accordingly, the video analysis system 120 may be configured to identify one or more portions of the video data 604 and associated attributes 608. By way of example, and not limitation, the video analysis system 120 may be configured to identify portion 606(2) of the video data 606(2) and an attribute 608(3) indicating that a user (e.g., employee) associated with the portion 606(2) is dissatisfied. Additionally, or alternatively, the video analysis system 120 may identify attribute 608(4) associated with the portion 606(2), where the attribute 608(4) indicates a high-frequency quote that users (e.g., employees) are saying (e.g., that “the elevator is broken”).

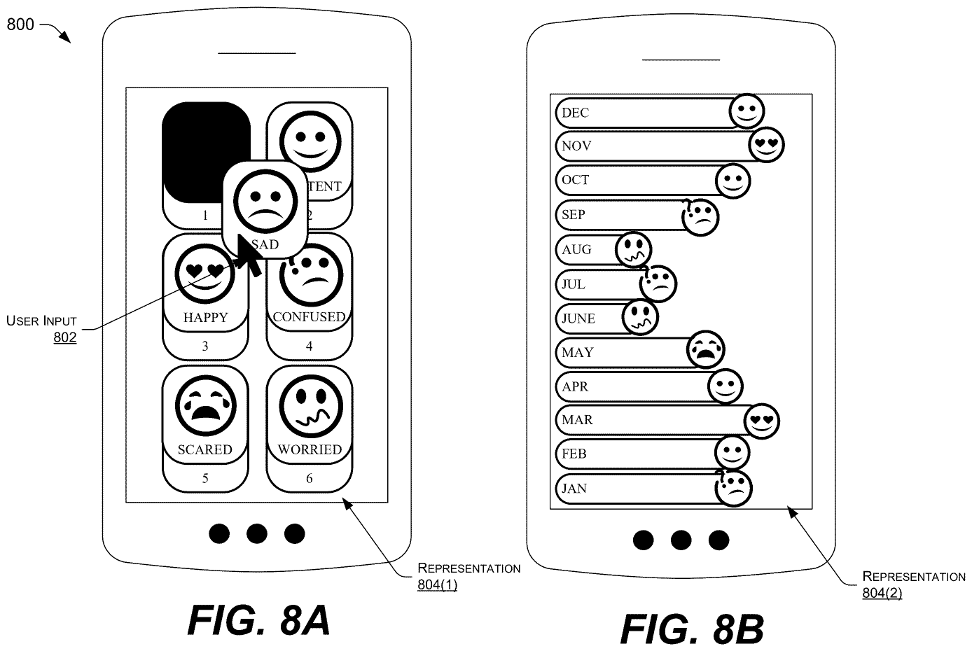

In some instances, and as described in more detail below with respect to FIGS. 8A and 8B, the video analysis system 120 may be configured to generate a representation 610 associated with the output. Continuing from the example above, the video analysis system 120 may be configured to generate an output including one or more portions of the video data 604 as well as attributes 608 such as an identification of particular users (e.g., one or more employees), particular quotes, a number of instances a particular topic was discussed, etc. Based on the output, the video analysis system 120 may generate a representation 610 indicating the video portions 606, attributes 608 (e.g., particular users, quotes, etc.), and/or other metrics such as an aggregation of instances a particular topic was discussed, a common psychological trait, etc.

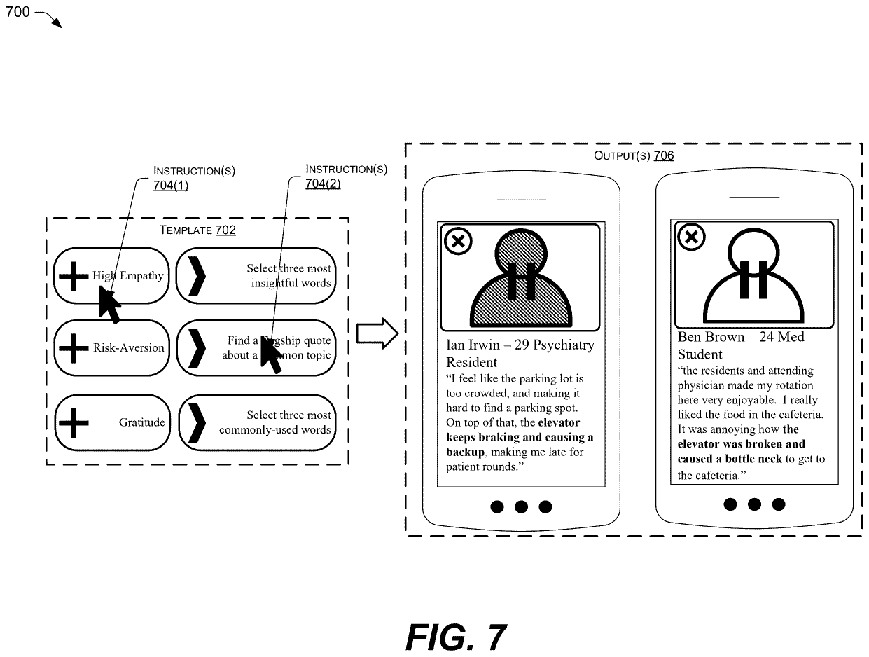

FIG. 7 illustrates an example process 700 and related user interfaces for the use of templates 702 to filter user videos and subsequent output, accordingly to at least some examples.

The video analysis system 120 may be configured to determine a template 702 that is usable to gain insights associated with user data, such as video data 604, described above. The template 702 may be determined based on video data 604. For example, the video analysis system 120 may determine attributes associated with video data 604. Attributes may indicate a demeanor, voice inflection, conduct, behavior, attitude, and/or the like. The template 702 may be determined based on the attributes. By way of example, and not limitation, the video analysis system 120 may receive video data 604 corresponding to a company's daily briefings, such as capturing the contents of the daily briefings. The video analysis system 120 may determine, based on the video data 604, one or more attributes associated with the video data 604 and/or users associated with the video data 604. For example, the video analysis system 120 may determine that the employees depicted in the video data 604 and/or subject matter of the video data 604 (e.g., employees engaging in daily briefings) are associated with attributes such as psychological insights (e.g., high empathy, risk-aversion, gratitude, agreeableness, etc.). As such, one or more templates 702 may be based on the attributes associated with the employees depicted in the video data 604. As illustrated, a template 702 determined by the video analysis system 120 may include an indication of the determined attributes associated with the video data 604, such as an indication of insights such as high empathy, risk-aversion, and gratitude. The template 702 may be usable to receive user input (e.g., instructions 704) associated with an entity. For example, the video analysis system 120 may receive, via the template 702, instruction(s) 704(1) indicating an attribute indicated by the template 702, such as high empahty. As illustrated, the template 702 may include an indication of a group of attributes (e.g., high empathy, risk-aversion, and gratitude) where the instruction(s) 704(1) indicates a selection of one or more attributes of the group of attributes (e.g., the instruction 704(1) may indicate a selection of high empathy, but not risk-aversion or gratitude). Additionally, or alternatively, the template 702 may be determined by the video analysis system 120 independently from video data 604, and instead based on one or more attributes associated with an entity (e.g., based on business goals, company missions, etc.). The template 702 may be determined independently of video data. Additionally, or alternatively, the template 702 may include an indication of one or more general insights. As illustrated, the template 702 may include an indication of one or more insights such as “three most insightful words,” “find a flagship quote about a common topic” and/or “select three most commonly-used words.” The one or more insights may be included in the template 702 as a group of insights, where instruction(s) 704(2) may include a select of one of the insights (e.g., “find a flagship quote about a common topic”).

As described above, the video analysis system 120 may be configured to generate an output, such as output(s) 706. For example, as illustrated, instruction(s) 704(2) may include a selection of a general insight of “find a flagship quote about a common topic.” Accordingly, the video analysis system may be configured to identify one or more portions of video data 604 corresponding to the insight, quotes corresponding to the insight, and/or other attributes. For example, output(s) 706 may include an indication of users (e.g., employees Ian Irwin and Ben Brown), portions of video data 604 corresponding to the users, as well as quotes pertaining to a common topic (e.g., that the elevator is frequently broken). As illustrated, and as discussed in more detail with respect to FIGS. 8A and 8B, the output(s) 706 may be included as part of a representation (e.g., representation at a display of a device).

FIGS. 8A and 8B illustrate example user interfaces 800 for user interaction and analytics, accordingly to at least some examples.

As described above, an output determined by the video analysis system 120 may be associated with a display and/or otherwise represented. For example, as illustrated in FIG. 8A, outputs may be represented by representation 804(1) at a user interface, such as a user device. By way of example, and not limitation, the video analysis system 120 may determine based on one or more templates, instructions, and/or the like, particular attributes associated with one or more portions of video data. For example, as illustrated, the video analysis system 120 may determine an aggregation of different attributes associated with video data (e.g., different psychological insights associated with employees, such as sad, content, happy, confused, scared, worried, etc.). In some instances, the representations 804 generated by the video analysis system 120 may be configured to elicit further user input, such as user input 802. For example, the video analysis system 120 may be configured to cause representation 804(1) to be displayed at a user interface device. Further, the video analysis system 120 may be configured to generate the representation 804(1) such that user input 802 may be received at the user interface (e.g., selectable, movable, etc. user interface components). By way of example, and not limitation, the representation 804(1) may include user interface components associated with high-frequency attributes, such as psychological insights, where user input 802 may be received via a user interface component in order to organize, or rank, the frequency attributes (e.g., an agent of a hospital may use the representation 804(1) to rank the frequency of certain emotions amongst hospital staff). Based on the user input 802, the video analysis system 120 may be configured to provide further analysis (e.g., a score of how well the agent of the hospital knows the emotional state of hospital employees).

Additionally, or alternatively, as described above, the video analysis system 120 may generate an output identifying insights such as common words, phrases, emotions, etc. In instances where instructions indicate a request for general insights, the video analysis system 120 may output insights such as high-frequency attributes, low-frequency attributes, and/or the like. Accordingly, a representation may include an indication of the insights (e.g., a ranking of attributes, such as emotions, as a function of frequency). Additionally, or alternatively, as illustrated in FIG. 8B, a representation 804(2) may include an indication of insights as a function of time. By way of example, and not limitation, video data may be collected by the video analysis system 120 over a period of one year. Based on the video data, the video analysis system 120 may determine changes in attributes of the period of one year (e.g., attributes of employees participating in daily briefings and depicted in video data). As such, the representation 804(2) may include an indication of the average, or common, attribute of employees for each month over the period of one year.

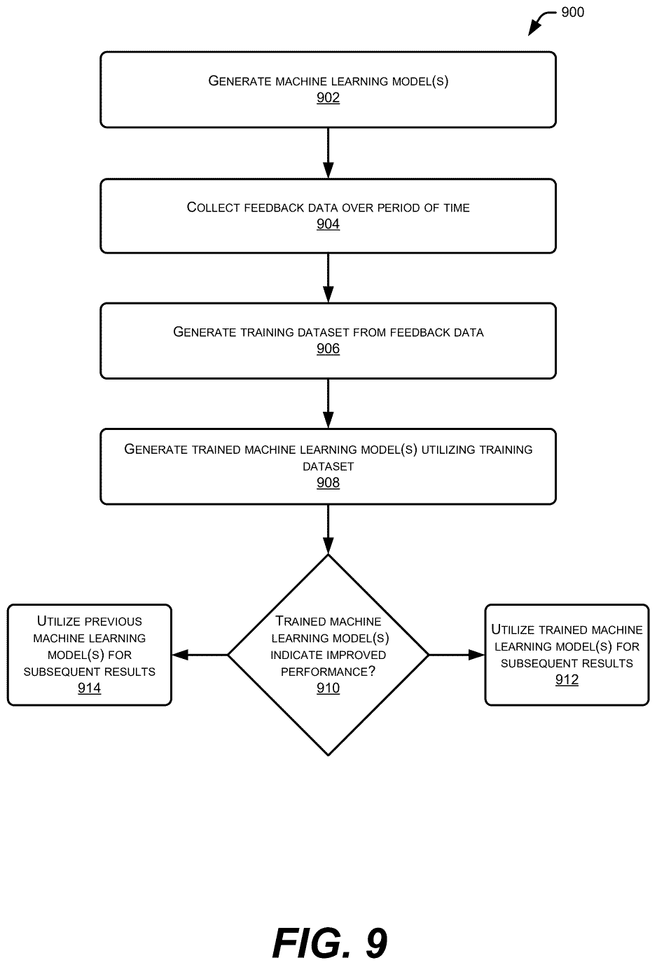

FIG. 9 illustrates example process for the generation of a machine learning model and the use of the same. The order in which the operations or steps are described is not intended to be construed as a limitation, and any number of the described operations may be combined in any order and/or in parallel to implement process 900.

At block 902, the process 900 may include generating one or more artificial intelligence models, such as a machine learning model. A number of artificial intelligence techniques may be employed to generate and/or modify the layers and/or models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based artificial intelligence.

At block 904, the process 900 may include collecting feedback data over a period of time. The feedback data may include any data described with respect to FIGS. 1-5, or any other data that may be used to perform the operations described herein.

At block 906, the process 900 may include generating a training dataset from the feedback data. Generation of the training dataset may include formatting the feedback data into input vectors for the artificial intelligence model to intake.

At block 908, the process 900 may include generating one or more trained artificial intelligence models using the training dataset. Generation of the trained artificial intelligence models may include updating parameters and/or weightings and/or thresholds used by the models to analyze video data.

At block 910, the process 900 may include determining whether the trained artificial intelligence models indicate improved performance metrics. For example, a testing group may be generated where attributes and/or sentiments associated with video data are known, but not to the trained artificial intelligence models. The trained artificial intelligence models may generate results, which may be compared to the known results to determine whether the results of the trained artificial intelligence model produce a superior result than the results of the artificial intelligence model prior to training.

In examples where the trained artificial intelligence models indicate improved performance metrics, the process 900 may include, at block 912, using the trained artificial intelligence models for generating subsequent results. For example, the trained artificial intelligence models may be used to calibrate confidence score thresholds and the like. It should be understood that the trained artificial intelligence models may be used in any scenario where models are used as described herein.

In examples where the trained artificial intelligence models do not indicate improved performance metrics, the process 900 may include, at block 914, using the previous iteration of the artificial intelligence models for generating subsequent results. Additionally, or alternatively, the process 900 may include, at block 914, reverting back to block 904 and collecting more feedback data over a period of time.

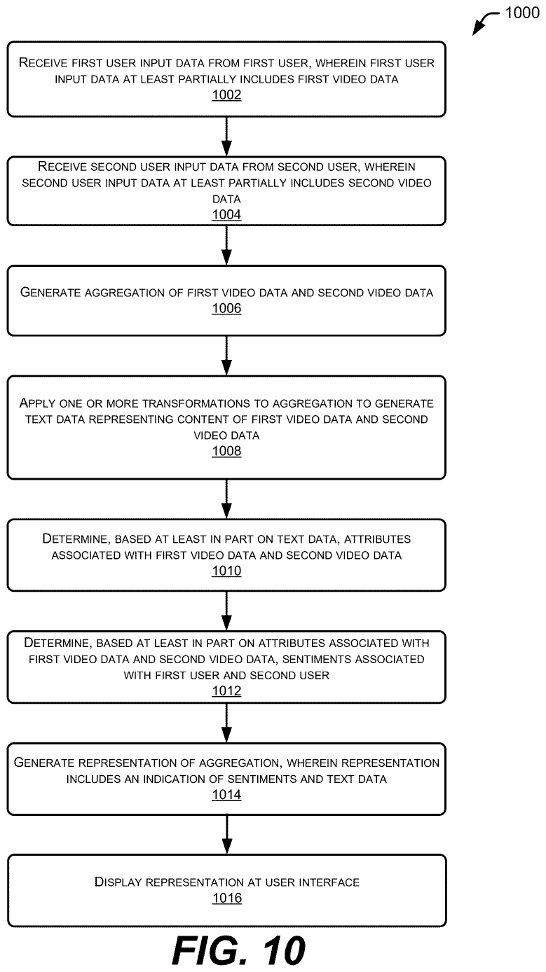

FIGS. 10-14 illustrate flowcharts outlining example methods, according to at least some examples. Various methods are described with reference to the example systems of FIGS. 1-9 for convenience and ease of understanding. However, the methods described are not limited to being performed by the example systems of FIGS. 1-9, and may be implemented using systems and devices other than those described herein.

The techniques may be applied by a system comprising one or more processors, and one or more non-transitory computer-readable media storing computer-executable instructions that, when executed by the one or more processors, cause the one or more processors to perform operations of method 1000, 1100, 1200, 1300, and/or 1400.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the methods may be omitted entirely. Moreover, the methods described herein can be combined in whole or in part with one another, and/or with other methods.

FIG. 10 illustrates a flowchart outlining an example method for complex video data analytics for sentiment determinations, according to at least some examples.

At block 1002, the method 1000 may include receiving first user input data from a first user, wherein the first user input data at least partially includes first video data.

At block 1004, the method 1000 may include receiving second user input data from a second user, wherein the second user input data at least partially includes second video data.

At block 1006, the method 1000 may include generating an aggregation of the first video data and the second video data. For example, a user of a video analysis system may include an individual user, business, corporation, entity, enterprise, and/or the like (collectively referred to as “entity”). For example, the entity may use the video analysis system in order to gain insights via video data for products and/or services associated with the entity. In some instances, the entity may use the video analysis system in order to gain insights via video data for internal procedures, employee feedback, event content, and/or the like. For example, the entity may provide user input data to the video analysis system, which may indicate a request for video data from one or more users. Additionally, or alternatively, the video analysis system may receive user data from the one or more users, which may include video data, audio data, image data, and/or the like (collectively referred to as “video data”). For example, the video data may include a video recorded by the user, a video depicting the user and/or the user speaking, a video of the environment of the user and/or the user speaking, etc. In some examples, the video data from the one or more users may be provided to the video analysis system in response a prompt, as described in more detail below. In some examples, the video data from the one or more users may be provided to the video analysis system unprompted. Additionally, or alternatively, the video analysis system may be configured to receive user data, and in turn, video data, from multiple users. In instances where the video analysis system receives video data from multiple users, the user data and/or video data may be aggregated and/or stored collectively such that the user data is accessible to the entity. For example, the user data may be accessible via a user interface associated with the video analysis system.

At block 1008, the method 1000 may include applying one or more transformations to the aggregation to generate text data representing content of the first video data and the second video data. For example, the video analysis system may be configured to apply one or more transformations to the aggregated user data and/or video data in order to generate text data. The text data may represent the content of a video associated with the video data. For example, the text data may represent user utterances, phrases, and/or otherwise transcribe the content of the video. In some examples, the text data may be associated with a searchable format.

At block 1010, the method 1000 may include determining, based at least in part on the text data, attributes associated with the first video data and the second video data. For example, the video analysis system may be configured to determine attributes associated with the video data and/or text data. In some examples, the attributes may include attributes of the user associated with the video data. For example, the attributes may indicate a demeanor, voice inflection, conduct, behavior, attitude, and/or the like of a user included in the video. Additionally, or alternatively, the attributes may include attributes of the content of the video data. For example, the attributes may indicate positive language (e.g., a user in the video saying “I love this commercial”) and/or negative language (e.g., a user in the video saying “I really did not like how long this commercial was”). In some instances, the attributes may be determined using a machine learning model that is trained to determine attributes based on text data, video data, and/or the like. For example, the video analysis system may use computer vision techniques to determine attributes based on video data.

At block 1012, the method 1000 may include determining, based at least in part on the attributes associated with the first video data and the second video data, sentiments associated with the first user and the second user. For example, based on the attributes, the video analysis system may determine sentiments. The sentiments may be associated with the entity and/or the user in the video. For example, sentiments associated with the entity may include a user value, feeling, perspective, etc. associated with a brand, entity, etc. In some instances, sentiments may include any information that may be usable by a brand and/or entity to gain user (e.g., consumer, employee, etc.) insights. Additionally, or alternatively, sentiments may be determined by the video analysis system on a per-user and/or per-video basis (e.g., for each user and associated video data), or the sentiments may be determined by the video analysis system for an entire aggregation of video data (e.g., sentiments representing the content included in all user videos, determined based on the sentiment of the first user and the sentiment of the second user). For example, in instances where user data has been received from multiple users, a sentiment may be determined for a first user based on their respective video data, and another sentiment may be determined for a second user based on their respective video data. The video analysis system may be configured to use both sentiments to determine an overall sentiment associated with the entity. Additionally, or alternatively, the video analysis system may be configured to determine sentiments associated with video data as a function of time. For example, attributes associated with the video data may indicate a positive sentiment at a first instance of the video data, and a negative sentiment at a second instance of the video data. As part of this, the video analysis system may be configured to correlate individual times comprising the video data with individual sentiments. In some instances, the sentiments may be determined using a machine learning model that is trained to determine sentiments based on attributes.

At block 1014, the method 1000 may generating a representation of the aggregation, wherein the representation includes an indication of the sentiments and the text data. For example, sentiment data may be provided to the entity. For example, the video analysis system may be configured to generate a representation including the aggregation of user data (e.g., an aggregation of video data), an indication of the sentiments, the text data, and/or the like. Additionally, or alternatively, the representation may include an indication of the sentiments associated with video data as a function of time.

At block 1016, the method 1000 may include displaying the representation at a user interface. For example, the representation may further be displayed at a user interface associated with the video analysis system and accessible by the entity. Additionally, or alternatively, the user interface may be configured to further receive user input data from the entity (e.g., agents of the entity). For example, an agent of the entity may provide user input data indicating a selection of a portion of the text data. In other words, the agent may otherwise “highlight” a portion of the text data. For example, the agent may highlight a portion of the text data based on the portion being of particular importance to the agent and/or entity. Accordingly, the video analysis system may update the representation at the user interface to include an indication of the selected portion of the text data. For example, the video analysis system may include an indication of a portion of the video data that corresponds to the selected portion of the text data.

Additionally, or alternatively, the method 1000 may further include receiving, third user input data from a third user and at the user interface, the third user input data indicating a selection of a first portion of the text data, and updating the representation to include an indication of the selection of the first portion of the text data.

Additionally, or alternatively, the method 1000 may further include receiving fourth user input data from the third user and at the user interface, the fourth user input data indicating a selection of a second portion of the text data, determining a category associated with the first portion and the second portion of the text data, identifying portions of video data that correspond to the first portion and the second portion of the text data, and updating the representation to include an indication of the category, wherein the category includes the portions of video data.

Additionally, or alternatively, the method 1000 may further include generating, based at least in part on the text data, a first machine learning model configured to determine attributes associated with video data aggregations, wherein determining the attributes associated with the first video data and the second video data is further based at least in part on the first machine learning model, and generating, based at least in part on attribute data associated with video data aggregations, a second machine learning model configured to determine user sentiments, wherein determining the sentiments associated with the first user and the second user is further based at least in part on the second machine learning model.

Additionally, or alternatively, the method 1000 may further include generating, based at least in part the sentiments, a machine learning model configured to determine trends associated with video aggregation, determining, based at least in part on the machine learning model, a correlation between a first sentiment associated with the first user and a second sentiment associated with the second user, based at least in part on the correlation, generating trend data associated with the aggregation, and updating the representation to include an indication of the trend data.

Additionally, or alternatively, the method 1000 may further include identifying times associated with the aggregation, and determining a correlation between first times of the times and first sentiments of the sentiments, wherein the representation includes a graphical representation of the correlation.

Additionally, or alternatively, the method 1000 may further include receiving third user input data from a third user and at the user interface, wherein the third user input data includes an indication of a particular attribute from the attributes associated with the first video data and the second video data, determining whether a particular portion of the aggregation correspond to the particular attribute, and based at least in part on determining that the particular portion of the aggregation corresponds to the particular attribute, including the particular portion of the aggregation in the representation, or based at least in part on determining that the particular portion of the aggregation does not correspond to the particular attribute, refraining from including the particular portion of the aggregation in the representation.

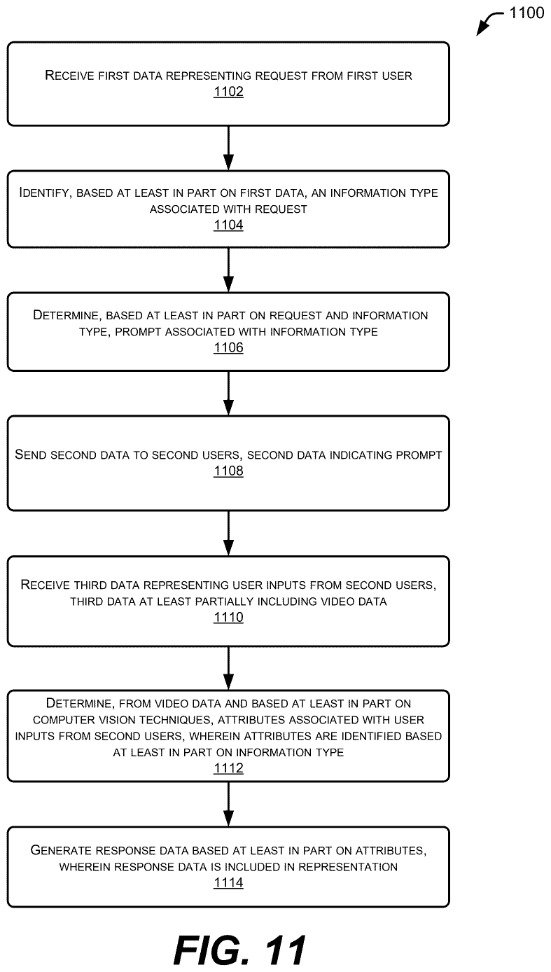

FIG. 11 illustrates a flowchart outlining an example method for prompt generation and use thereof for complex video data analytics, according to at least some examples.

At block 1102, the method 1100 may include receiving first data representing a request from a first user. For example, the video analysis system may receive user input data from an entity, where the user input data may include a request from the entity (e.g., a request to receive particular user feedback and/or response data). The video analysis system may be configured to, based on the user input data and/or other types of data, generate a prompt, such as a video invitation that is sent to end users with instructions for the end users to provide video feedback.

At block 1104, the method 1100 may include identifying, based at least in part on the first data, an information type associated with the request. For example, the request may include an indication of information types, where the entity would receive particular user feedback and/or response data for the information types. An information type may include an indication of a purpose associated with the entity (e.g., general engagement, contest, video for use, feedback, and/or the like). Additionally, or alternatively, the video analysis system may be configured to identify information types based on the request and/or the user input data.

At block 1106, the method 1100 may include determining, based at least in part on the request and the information type, a prompt associated with the information type. For example, the video analysis system may use, or work in combination with, a machine learning component. The machine learning component may include a machine learning model (e.g., generative artificial intelligence) configured to generate prompts, or video invitations, for end users based on user input data from an entity and/or other types of data (e.g., user data, sentiment data, etc.). Further, based on the information types and/or the user input, the video analysis system may determine the prompt, which may be sent to one or more users (e.g., individuals, consumers, etc.). By way of example, and not limitation, based on a request including an information type indicating a purpose of general engagement, the video analysis system may be configured to determine a prompt to be sent to the one or more users, such that the video analysis system may receive user data from the one or more users containing video data associated with general engagement.

At block 1108, the method 1100 may include sending second data to second users, the second data indicating the prompt. For example, the video analysis system may determine an instance (e.g., time) and/or context at which a prompt is to be sent and/or made available to one or more users. The video analysis system may use an information type and/or prompt to determine the instance and/or context at which prompt data indicating the prompt is to be sent and/or made available to one or more users. For example, the information type and/or prompt may indicate a purpose associated with the entity to receive feedback regarding a football movie. Accordingly, the video analysis system may be configured to determine that the prompt associated with receiving feedback regarding a football movie is to be made available during a professional football game (e.g., displaying a prompt, or video invitation, at a user interface of an end user while a professional football game is airing), and at a peak time (e.g., 5 P.M. on a Sunday). As such, the video analysis system may be configured to send prompt data indicating the prompt such that the prompt is sent, made available, and/or displayed to one or more users at 5 P.M. on a Sunday during a professional football game. While prompt data may be sent directly to one or more users (e.g., to user devices), the video analysis system may further be configured to generate a link, quick-response (QR) code, and/or the like to display at one or more user devices, such that the one or more users may access the prompt and provide user input data. This way, links, QR codes, and/or the like may be displayed at one or more user devices without interrupting content associated with the user devices.

At block 1110, the method 1100 may include receiving third data representing user inputs from the second users, the third data at least partially including video data. For example, the video analysis system may receive user data from one or more users in response to a prompt, and may further be configured to determine attributes associated with the users.

At block 1112, the method 1100 may include determining, from the video data and based at least in part on computer vision techniques, attributes associated with the user inputs from the second users, wherein the attributes are identified based at least in part on the information type. The attributes may indicate a demeanor, voice inflection, conduct, behavior, attitude, and/or the like of a user included in the video. The attributes may include attributes of the content of the video data. In some instances, the attributes may be determined by the video analysis system based on computer vision techniques. The video analysis system may be configured to determine attributes based at least in part on the information types included in, and/or identified from, the request and/or user input data of the entity. By way of example, and not limitation, based on a request including an information type indicating a purpose of general engagement, the video analysis system may be configured to determine attributes that correspond to general engagement.

At block 1114, the method 1100 may include generating response data based at least in part on the attributes, wherein the response data is included in a representation. For example, based on the attributes determined by the video analysis system, the video analysis system may further be configured to generate response data for the entity. For example, response data may include an indication of the attributes, sentiments determined based on the attributes, analytics, feedback, insights, etc. associated with the user data received by the video analysis system. For example, the response data may include video data (e.g., video data from multiple users), text data representing the content of the video data, different portions of video data, sentiment data, and/or the like.

Additionally, or alternatively, the method 1100 may further include determining, based at least in part on the video data, embedding representations associated with each of the user inputs from the second users, identifying a first embedding representation associated with a first user input of the user inputs, identifying a second embedding representation associated with a second user input of the user inputs, wherein the second embedding representation is different from the first embedding representation, and determining the attributes associated with the user inputs based at least in part on the second embedding representation being different from the first embedding representation.

Additionally, or alternatively, the method 1100 may further include determining an aggregation of the attributes associated with the user inputs, and determining an overall sentiment associated with the user inputs based at least in part on the aggregation of the attributes, wherein generating the response data is further based at least in part on the overall sentiment.

Additionally, or alternatively, the method 1100 may further include wherein sending the second data indicating the prompt further includes generating, at a user interface associated with the second users, at least one of a link or a quick-response (QR) code indicating the prompt.

Additionally, or alternatively, the method 1100 may further include generating, based at least in part on the video data, a machine learning model configured to determine the attributes associated with the user inputs, and determining, using the machine learning model, a first attribute associated with a first user input of the user inputs, wherein generating the response data is further based at least in part on the first attribute.

Additionally, or alternatively, the method 1100 may further include generating, based at least in part on the video data, a machine learning model configured to determine correlations between the user inputs and the prompt, identifying, using the machine learning model, a correlation between a first user input of the user inputs and the information type, determining a threshold for the correlations between the user inputs and the prompt, determining whether the correlation violates the threshold, and based at least in part on determining that the correlation violates the threshold, removing the first user input from the third data, or based at least in part on determining that the correlation does not violate the threshold, refraining from removing the first user input from the third data.

Additionally, or alternatively, the method 1100 may further include determining, based at least in part on the information type associated with the request, an instance at which the prompt is to be sent, and sending the second data to the second users based at least in part on the instance.

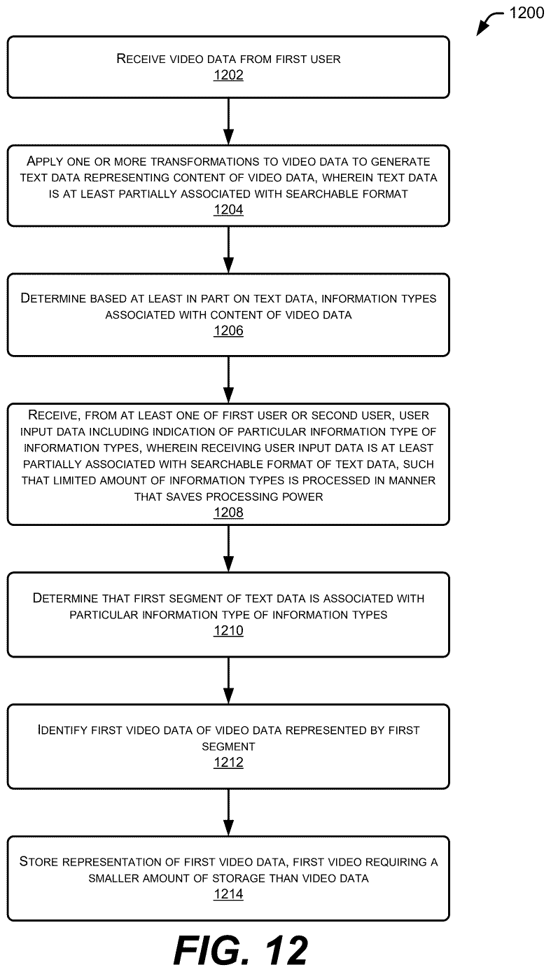

FIG. 12 illustrates a flowchart outlining an example method for complex video data analytics and content moderation, according to at least some examples.

At block 1202, the method 1200 may include receiving video data from a first user. For example, the video analysis system may receive user data, which may include video data, from an entity and/or user. In some instances, the video data may be longer in duration (e.g., associated with a video representing the content of a week-long conference). Additionally, the entity may be associated with the content of the video included in the video data (e.g., an administrator of the conference, and/or the like). In some examples, the entity may be able to enable, restrict, and/or otherwise control access to the video data. For example, the video analysis system may receive user data from the entity, which may include video data. Additionally, or alternatively, the video analysis system may receive user input data from the entity, which may indicate access controls associated with the video data. For example, the access controls may include particular user accounts that are allowed to access the video data, user accounts associated with the video data (e.g., an attendee of the conference), device types that are allowed access to the video data, and/or other access control lists (ACLs). Additionally, the access controls may include a particular duration of time in which a user, user account, device type, etc. has access to the video data. For example, the access controls may include a threshold period of time for accessing the video data. The threshold period of time may be associated with the video data, and/or may be associated with a particular user (e.g., different users have different periods of time in which they can access the video data). In some examples, users may access the video data through a user interface associated with a user device, which may be communicatively coupled to the video analysis system. Additionally, or alternatively, the user device may be communicatively coupled to the video analysis system through a service provider platform, such as a content moderation platform.

At block 1204, the method 1200 may include applying one or more transformations to the video data to generate text data representing content of the video data, wherein the text data is at least partially associated with a searchable format. For example, the video analysis system may apply one or more transformations to the video data to generate text data representing the video data (e.g., a transcription of the content of the video associated with the video data). In some examples, the text data may be associated with a searchable format.

At block 1206, the method 1200 may include determining, based at least in part on the text data, information types associated with the content of the video data. For example, based on the text data, information types associated with the content of the video data may be determined. For example, information types may include particular portions of the text data pertaining to a particular topic.

At block 1208, the method 1200 may include receiving, from at least one of the first user or a second user, user input data including an indication of a particular information type of the information types, wherein receiving the user input data is at least partially associated with the searchable format of the text data, such that a limited amount of the information types is processed in a manner that saves processing power. For example, the video analysis system may receive user input data from the entity, or from one or more additional users, which may include an indication of a particular information type from the information types. For example, the user input data may include a “search” from the first user and/or the second user (e.g., a search for a particular word, phrase, person, etc.), an indication of a particular portion of the text data (e.g., a user “highlight” of the text data), and/or the like. In some examples, the video analysis system may use, or work in combination with, a machine learning component to identify information types associated with, and/or included in, the text data and associated with the video data. Additionally, or alternatively, the video analysis system may use, or work in combination with, a machine learning component to perform voice and/or facial recognition techniques with respect to the video data to generate voice data and/or facial data. Based at least in part on the voice data and/or facial data, information types may be identified and/or determined.

At block 1210, the method 1200 may include determining that a first segment of the text data is associated with the particular information type of the information types. For example, segments of the text data that are associated with the particular information type may be determined and/or identified. For example, the video analysis system may identify a first segment of text data (e.g., for a transcription of a week-long conference, a segment on a particular panel provided at the conference) and a second segment of text data (e.g., for the transcription of the week-long conference, a segment on ancillary information to the conference, such as catering).

At block 1212, the method 1200 may include identifying first video data of the video data represented by the first segment. For example, the video analysis system may also be configured to correlate, or otherwise identify, video data that is represented by the segments (e.g., the portion of the video data that corresponds to text data included in the first segment). The video analysis system may also be configured to store a representation of the video data that is represented by the segments. This way, the entity may be able to access particular portions of the full-length video data easily and quickly. For example, as described above, the entity may enable users to access the video data. Similarly, one or more additional users may be able to provide user input data indicating a particular information type, where segments of the text data that are associated with the particular information type may be determined and/or identified.

At block 1214, the method 1200 may include storing a representation of the first video data, the first video data requiring a smaller amount of storage than the video data. For example, the video analysis system may further be configured to generate a representation, or heat map, of user input data indicating particular information types. For example, in instances where multiple users provide user input data indicating the same information type, the representation may include an indication of the same information type being prevalent, popular, and/or otherwise associated with multiple users. Additionally, or alternatively, a device associated with the entity may be communicatively coupled to the video analysis system through the service provider platform, such as a content moderation platform. As such, the representation (e.g., heat map) of user input data indicating particular information types may be displayed for the entity at the content moderation platform.

Additionally, or alternatively, the method 1200 may further include determining that a second segment of the text data is associated with the particular information type, based on the first segment and the second segment being associated with the particular information type, identifying a correlation between the first segment and the second segment, identifying second video data of the video data represented by the second segment, and storing a representation of the first video data and the second video data.

Additionally, or alternatively, the method 1200 may further include, wherein the user input data is first user input data, receiving second user input data including the indication of the particular information type of the information types, determining that a second segment of the text data is associated with the particular information type, identifying second video data of the video data represented by the second segment, storing a representation of the first video data and the second video data, receiving, third user input data associated with the representation, and updating the representation based at least in part on the third user input data.

Additionally, or alternatively, the method 1200 may further include, wherein the user input data is first user input data, receiving, from the first user, second user input data indicating access controls associated with the video data, determining, based at least in part on the access controls, whether the second user is permitted to access the video data, and based at least in part on determining that the second user is permitted to access the video data, receiving, from the second user, third user input data including the indication of the particular information type of the information types, or based at least in part on determining that the second user is not permitted to access to the video data, refraining from receiving, form the second user, the third user input data.

Additionally, or alternatively, the method 1200 may further include wherein the access controls comprise at least one of user accounts associated with the second user, user accounts associated with the video data, device types associated with the video data, or a threshold period of time associated with the video data.

Additionally, or alternatively, the method 1200 may further include generating, based at least in part on the video data, a machine learning model configured to determine the information types associated with the content of the video data, and determining, based at least in part on the text data and the machine learning model, the information types associated with the content of the video data.

Additionally, or alternatively, the method 1200 may further include wherein the user input data is first user input data received from the second user, receiving, from a third user, second user input data including an indication of the particular information type of the information types, receiving, from a fourth user, third user input data including the indication of the particular information type of the information types, generating a representation of the second user input data and the third user input data, and causing a display of the representation at a device associated with the first user.

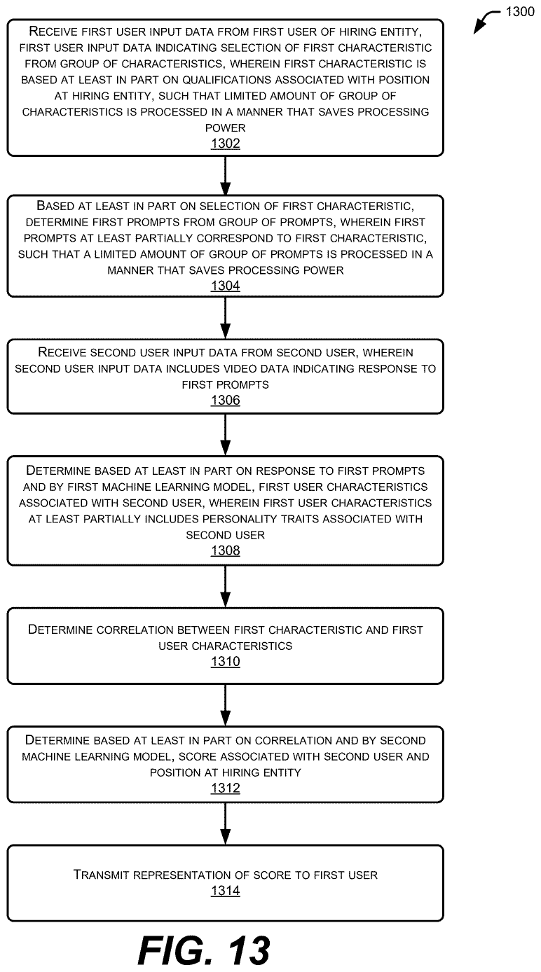

FIG. 13 illustrates a flowchart outlining an example method for complex video data analytics and scoring determinations, according to at least some examples.

At block 1302, the method 1300 may include receiving first user input data from a first user of a hiring entity, the first user input data indicating a selection of a first characteristic from a group of characteristics, wherein the first characteristic is based at least in part on qualifications associated with a position at the hiring entity, such that a limited amount of the group of characteristics is processed in a manner that saves processing power. For example, the video analysis system may receive user input data from a first user, such as an agent associated with an entity, where the user input data may indicate a selection of characteristics from a group of characteristics (e.g., “problem-solver,” “proactive,” “emotional intelligence,” “interpersonal communication skills,” etc.). For example, the agent may be associated with hiring operations (e.g., recruiter, human resources professional, etc.) of the entity. Accordingly, the entity may select characteristics based on characteristics and/or qualifications required by a particular job position.

At block 1304, the method 1300 may include, based at least in part on the selection of the first characteristic, determining first prompts from a group of prompts, wherein the first prompts at least partially correspond to the first characteristic, such that a limited amount of the group of prompts is processed in a manner that saves processing power. For example, based at least in part on the selection of the characteristics, the video analysis system may be configured to determine prompts from a group of prompts, where the prompts at least partially correspond to the characteristics. For example, the prompt may be configured to identify whether one or more users, such as job applicants, have personality traits associated with a problem-solver, proactivity, emotional intelligence, interpersonal communication skills, etc.

At block 1306, the method 1300 may include receiving second user input data from a second user, wherein the second user input data includes video data indicating a response to the first prompts. For example, the video analysis system may subsequently receive user input data from the applicants that are responsive to the prompts. In some examples, the user input data may include video data, audio data, and/or the like. For example, video data from the applicants may include video recordings of the applicants, and their responses to the prompts (e.g., a prompt asking to “describe how you would solve a conflict with a coworker”).

At block 1308, the method 1300 may include determining, based at least in part on the response to the first prompts and by a first machine learning model, first user characteristics associated with the second user, wherein the first user characteristics at least partially includes personality traits associated with the second user. For example, based on the video data associated with the applicants, the video analysis system may determine user characteristics (e.g., personality traits, attributes, and/or the like) associated with the applicants. For example, the video analysis system may be configured to identify one or more characteristics associated with each of the applicants based on their individual responses to the prompts. In some instances, the video analysis system may use, or work in combination with, a machine learning component, such that a machine learning model may be used to determine the user characteristics associated with the applicants.

At block 1310, the method 1300 may include determining a correlation between the first characteristic and the first user characteristics. For example, the video analysis system may be configured to determine a correlation between the user characteristics from the applicants and the characteristics indicated by the entity (e.g., whether the applicant is a problem-solver, proactive, has emotional intelligence, interpersonal communication skills, etc.).

At block 1312, the method 1300 may include determining, based at least in part on the correlation and by a second machine learning model, a score associated with the second user and the position at the hiring entity. For example, based on the correlation, the video analysis system may determine a score associated with each of the applicants and/or their respective user characteristics. For example, the score may indicate the correlation between each individual user characteristic and each individual characteristic indicated by the entity. Additionally, or alternatively, the score may indicate an overall correlation for each applicant and the entity (e.g., the overall compatibility between a user and the entity). For example, scores above a particular threshold may indicate that the user characteristics for an applicant is correlated to the characteristics identified by the entity. Additionally, or alternatively, scores below a particular threshold may indicate that the user characteristics for an applicant is less closely correlated, and/or not correlated, to the characteristics identified the entity. The video analysis system may then be configured to transmit a representation of the score to the entity.

In some examples, the video analysis system may use, or work in combination with, a machine learning component, such that a machine learning model is used to determine scores associated with the applicants. In some instances, the entity may provide user input data indicating a prioritization, ranking, etc. associated with the characteristics. For example, the entity may provide user input data indicating that a characteristic is prioritized over another characteristic (e.g., prioritizing problem-solving over proactivity). Additionally, or alternatively, based on the prioritized characteristic, the video analysis system may be configured to weight the characteristics indicated by the entity and the characteristics associated with the applicants, where the weight may be used to determine the scores associated with the applicants. Additionally, or alternatively, the video analysis system may use, or work in combination with, a machine-learning component, such that a machine learning model is used to identify trends associated with the applicants and/or the user characteristics of applicants. For example, while the entity may provide user input data indicating characteristics from a group of characteristics (e.g., first characteristics) and/or prioritization of characteristics, the entity may identify user characteristics (e.g., second characteristics) associated with the applicants, but not correlated (e.g., a score below a threshold) to the first characteristics selected by the entity. For example, the video analysis system may identify a trend of second characteristics that are not correlated to the first characteristics, but are heavily prevalent amongst applicants based on the video data. Additionally, or alternatively, a machine learning model, such as generative artificial intelligence may use the trend of second characteristics amongst the applicants to generate and/or update the prompts made available to the applicants.

At block 1314, the method 1300 may include transmitting a representation of the score to the first user. For example, once the video analysis system has determined scores associated with each of the users, the video analysis system may transmit score data indicating the scores to the entity. For example, the video analysis system may be configured to cause score data to be displayed at a user interface component of a device associated with the entity. In some examples, the video analysis system may cause other data to be displayed at the user interface component of the device associated with an agent of the entity. For example, similarly to the techniques described above, the video analysis system may generate text data from the video data of the applicants (e.g., a transcript of the responses to the prompts for each of the applicants). Additionally, or alternatively, the video analysis system may cause the text data to be displayed at the user interface component. This way, the entity may be able to view the one or more scores associated with each of the applicants, as well as a transcript of their responses, all while maintaining the anonymity of each of the applicants. For example, the video analysis system may be configured to apply one or more transformations to the user input data from applicants, user characteristics, text data, and/or score data in order to obscure and/or redact personally identifiable information (e.g., age, gender, race, ethnicity, disability, and/or the like) associated with the applicants. An agent of the entity may otherwise reveal the personally identifiable information if the video analysis system determines that the agent is an authorized user, a condition has been satisfied (e.g., score data indicating the scores to the entity have been transmitted, and applicants with scores below a threshold have been removed from consideration, etc.). The video analysis system may also be configured to perform similar analytics techniques as described above with respect to the text data (e.g., identify portions and/or segments, generate sentiment data, etc.).

Additionally, or alternatively, the method 1300 may further include, wherein the correlation is a first correlation, and the score is a first score, receiving the first user input data from a first user, the first user input data indicating a selection of a second characteristic from the group of characteristics, based at least in part on the selection of the second characteristic, determining second prompts from the group of prompts, wherein the second prompts at least partially correspond to the second characteristic, receiving the second user input data from the second user, wherein the second user input data is further based at least in part on the second prompts, determining, based at least in part on the second user input data and by the first machine learning model, second user characteristics associated with the second user, determining a second correlation between the second characteristic and the second user characteristics, determining, based at least in part on the second correlation and by the second machine learning model, a second score associated with the second user and the second characteristic, and transmitting a representation of the second score to the first user.

Additionally, or alternatively, the method 1300 may further include, wherein the correlation is a first correlation, and the score is a first score, receiving third user input data from a third user, wherein the third user input data is based at least in part on the first prompts, determining, based at least in part on the third user input data and by the first machine learning model, second user characteristics associated with the third user, determining a second correlation between the first characteristic and the second user characteristics, determining, based at least in part on the second correlation and by the second machine learning model, a second score associated with the third user and the first characteristic, and transmitting a representation of the second score to the first user.

Additionally, or alternatively, the method 1300 may further include, wherein the second user input data comprises at least one of video data or audio data, applying one or more transformations to the second user input data to generate text data representing the second user input data, receiving third user input from the first user, the third user input indicating a selection of a portion of the text data, and storing a representation of the portion of the text data.

Additionally, or alternatively, the method 1300 may further include receiving the first user input data from a first user, the first user input data further indicating a priority associated with the first characteristic, determining, based at least in part on the priority, a first weight associated with the first characteristic, wherein the first weight is applied to the first score, and determining, based at least in part on the priority, a second weight associated with the second characteristic, wherein the second weight is applied to the second score.

Additionally, or alternatively, the method 1300 may further include determining, based at least in part on the first weighted score and the second weighted score, an overall score associated with the second user, and transmitting a representation of the overall score to the first user.

Additionally, or alternatively, the method 1300 may further include wherein the first machine learning model is configured to determine user characteristics associated with users based on at least one of video data or audio data, and the second machine learning model is configured to determine scores associated with the users based on the user characteristics.

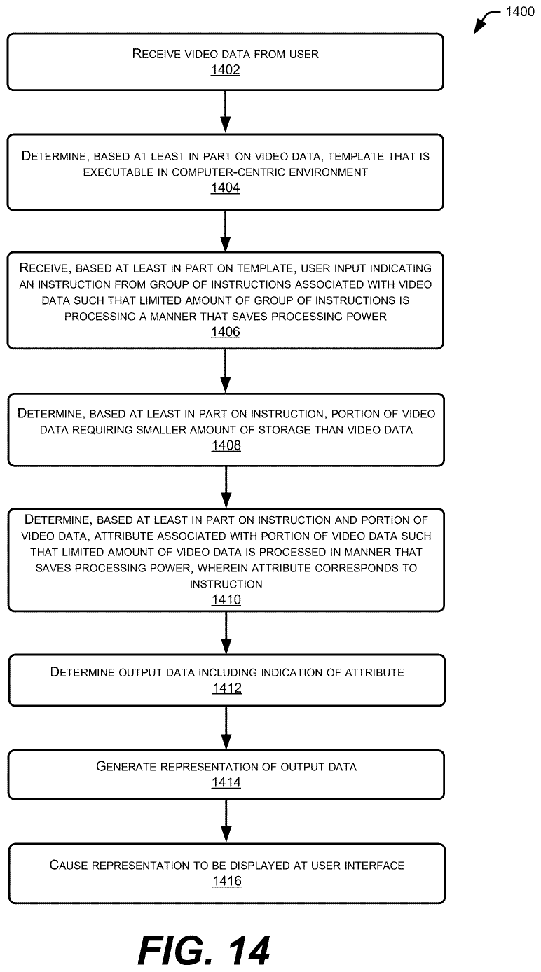

FIG. 14 illustrates a flowchart outlining an example method for the use of dynamic templates for video data filtration, analytics, and complex delivery.

At block 1402, the method 1400 may include receiving video data from a user. For example, as described above, the video analysis system may receive user data, such as video data, from one or more users in response to a prompt (e.g., video data in response to an employee survey) and may further be configured to determine attributes associated with the users (e.g., demeanor, voice inflection, conduct, behavior, etc.). Additionally, or alternatively, the video analysis system may receive user data such as video data that is longer in duration, an aggregation of video data, etc. (e.g., video data corresponding to one or more employee meetings, daily briefings, a conference, etc.). The video analysis system may receive the user data periodically (e.g., every day, week, month, etc.) or continuously. In some instances, the video analysis system may be pushed user data, or be configured to pull the user data (e.g., pull from an entity system via API calls). Additionally, or alternatively, the video analysis system may receive the user data after one or more triggers. For example, the video analysis system may receive user data after a particular event (e.g., after an employee meeting takes place).

At block 1404, the method 1400 may include, determining, based at least in part on the video data, a template that is executable in a computer-centric environment. In some examples, the video analysis system may be configured to determine a template that is usable to gain insights associated with the user data. The template may be determined based on the user data (e.g., based on video data). For example, as described above, the video analysis system may determine attributes associated with users, video data included in user data, and/or the like. Attributes may indicate a demeanor, voice inflection, conduct, behavior, attitude, and/or the like. The template may be determined based on the attributes. By way of example, and not limitation, the video analysis system may receive user data corresponding to a company's daily briefings, such as video data capturing the contents of the daily briefings. The video analysis system may determine, based on the video data, one or more attributes associated with the video data and/or users associated with the video data. For example, the video analysis system may determine that the employees depicted in the video data and/or subject matter of the video data (e.g., employees engaging in daily briefings) are associated with attributes such as psychological insights (e.g., high empathy, risk-aversion, gratitude, agreeableness, etc.). As such, one or more templates may be based on the attributes associated with the employees depicted in the video data. By way of example, and not limitation, a template determined by the video analysis system may include an indication of the determined attributes associated with the video data, such as an indication of insights such as high empathy, risk-aversion, gratitude, and/or agreeableness.

At block 1406, the method 1400 may include receiving, based at least in part on the template, user input indicating an instruction from a group of instructions associated with the video data such that a limited amount of the group of instructions is processed in a manner that saves processing power. For example, the template may be usable to receive user input (e.g., instructions) associated with an entity. For example, the video analysis system may receive, via the template, user input from an agent of the entity indicating one or more of the attributes indicated by the template. In some instances, the template may include an indication of a group of attributes, and user input may indicate a selection of one or more attributes of the group of attributes (e.g., the agent may select high empathy and risk-aversion, but not gratitude and agreeableness from an available list of psychological insights). Additionally, or alternatively, the template may be determined by the video analysis system independently from video data, and instead based on one or more attributes associated with an entity (e.g., based on business goals, company missions, etc.) and usable to gain insights associated with subsequent video data that is received by the video analysis system.

At block 1408, the method 1400 may include determining, based at least in part on the instruction, a portion of the video data requiring a smaller amount of storage than the video data. For example, based on the user input, or instructions, the video analysis system may be configured to generate an output. An output may include an identification of one or more users, user videos, etc. associated with the user data (e.g., video portions). For example, user input received by the video analysis system, and responsive to one or more templates, may include instructions indicating one or more attributes, or insights, that are important to an entity. By way of example, and not limitation, the video analysis system may receive user input associated with an entity (e.g., hospital) and including instructions indicating that attributes such as high empathy and risk-aversion are important to the entity. Based on the instructions, the video analysis system may be configured to generate an output. In some instances, the output may include identifications of particular users (e.g., hospital employees engaged in a daily briefing as depicted in video data), particular quotes, a number of instances a particular topic was discussed, and/or the like. In some instances, and as described in more detail below, the output may be based on one or more portions of video data and/or related attributes. For example, the video analysis system may be configured to identify one or more portions of video data based on user instructions (e.g., instructions indicating particular attributes), and further analyze the one or more portions of video data to identify attributes associated with the one or more portions of video data (e.g., particular users, particular quotes, a number of instances a particular topic was discussed, etc.).

At block 1410, the method 1400 may include determining, based at least in part on the instruction and the portion of the video data, an attribute associated with the portion of the video data such that a limited amount of video data is processed in a manner that saves processing power, wherein the attribute corresponds to the instruction. Continuing from the example above, user input may include instructions indicating the attributes of high empathy and risk-aversion. Based on the instructions, the video analysis system may identify one or more portions of video data. The video analysis system may also generate an output including an identification of one or more employees associated with the attributes of high empathy and/or risk-aversion.

At block 1412, the method 1400 may include determining output data including an indication of the attribute. Continuing from the example above, user input may include instructions indicating the attributes of high empathy and risk-aversion. Based on the instructions, the video analysis system may identify one or more portions of video data. The video analysis system may also generate an output including an identification of one or more employees associated with the attributes of high empathy and/or risk-aversion. Additionally, or alternatively, based on the instructions, the video analysis system may generate an output including an identification of one or more quotes and/or spoken words during the daily briefing and associated with the attributes of high empathy and risk-aversion. In some instances, the video analysis system may be configured to generate an output based on attributes not indicated in instructions. By way of example, and not limitation, the video analysis system may be configured to identify particular users, quotes, and/or the number of instances a particular topic was discussed based on other attributes not indicated in instruction. For example, the video analysis system may identify a common (e.g., high-frequency) attribute associated with video data, where the attribute is not indicated by the instructions. As such, the output may include an indication of the high-frequency attribute such that it is brought to the attention of an entity. Further, the video analysis system may be configured to identify one or more portions of video data and associated high-frequency attributes that are not indicated by the instructions. Additionally, or alternatively, as described above, user input may include instructions indicating general insights. In instances where user input includes instructions indicating general insights, the video analysis system may generate an output, using the techniques described herein, to identify one or more portions of video data including attributes such as high-frequency words, phrases, emotions, etc.

At block 1414, the method 1400 may include generating a representation of the output data. For example, the video analysis system may be configured to generate a representation associated with the output. Continuing from the example above, the video analysis system may be configured to generate an output including an identification of particular users (e.g., one or more employees), particular quotes, a number of instances a particular topic was discussed, etc. associated with particular attributes (e.g., high empathy and risk-aversion). Based on the output, the video analysis system may generate a representation indicating the particular users, particular quotes, number of instances a particular topic was discussed, etc. By way of example, and not limitation, a representation may include a graphic (image, video, and/or the like) of an employee associated with attributes of high empathy and risk-aversion. In some instances, the representation may include a graphic depicting the employee at a time at which the employee exhibited the attributes of high empathy and risk-aversion (e.g., portions of video data). Additionally, or alternatively, a representation may include an indication of particular quotes associated with the attributes of high empathy and risk-aversion (e.g., quotes spoken by employees during a daily briefing) and/or the employee that said such quote.

At block 1416, the method 1400 may include causing the representation to be displayed at a user interface. Continuing from the example above, the video analysis system may be configured to generate an output including an identification of particular users (e.g., one or more employees), particular quotes, a number of instances a particular topic was discussed, etc. associated with particular attributes (e.g., high empathy and risk-aversion). Based on the output, the video analysis system may generate a representation indicating the particular users, particular quotes, number of instances a particular topic was discussed, etc. By way of example, and not limitation, a representation may include a graphic (image, video, and/or the like) of an employee associated with attributes of high empathy and risk-aversion. In some instances, the representation may include a graphic depicting the employee at a time at which the employee exhibited the attributes of high empathy and risk-aversion (e.g., portions of video data). Additionally, or alternatively, a representation may include an indication of particular quotes associated with the attributes of high empathy and risk-aversion (e.g., quotes spoken by employees during a daily briefing) and/or the employee that said such quote.

Additionally, or alternatively, as described above, user input may include instructions indicating general insights, where the video analysis system may generate an output identifying insights such as common words, phrases, emotions, etc. In instances where the user input includes instructions indicating general insights, the video analysis system may output insights such as high-frequency attributes, low-frequency attributes, and/or the like. Accordingly, a representation may include an indication of the insights (e.g., a ranking of attributes, such as emotions, as a function of frequency). Additionally, or alternatively, based on an output, a representation may include an indication of insights as a function of time. By way of example, and not limitation, user data may include video data collected over a period of one year. Based on the video data, the video analysis system may determine changes in attributes of the period of one year (e.g., attributes of employees participating in daily briefings and depicted in video data). A representation may include an indication of the average, or common, attribute of employees for each month over the period of one year.

In some instances, the representations generated by the video analysis system may be configured to elicit further user input. For example, the video analysis system may be configured to cause one or more representations to be displayed at a user interface device. Further, the video analysis system may be configured to generate representations that may be usable to receive further user input at the user interface (e.g., representations including selectable, movable, etc. user interface components). By way of example, and not limitation, a representation may include user interface components associated with high-frequency attributes, such as emotions, where user input may be received via a user interface component in order to organize, or rank, the frequency attributes (e.g., an agent of a hospital may use the representation to rank the frequency of certain emotions amongst hospital staff). In another example, a representation may include interface components associated with a particular quote, where user input may be received via a user interface component in order to identify a particular user associated with the quote (e.g., an agent of a hospital may use the representation to identify, or guess, the hospital employee who said the particular quote).

Additionally, or alternatively, the method 1400 may further include, wherein the video data is first video data, and the attribute is a first attribute, receiving second video data, determining, based at least in part on the instruction, a portion of the second video data requiring a smaller amount of storage than the second video data, determining, based at least in part on the instruction and the portion of the second video data, a second attribute associated with the portion of the second video data such that a limited amount of the second video data is processed in a manner that saves processing power, wherein the second attribute corresponds to the instruction, and updating the output data based at least in part on the second attribute.

Additionally, or alternatively, the method 1400 may further include, wherein the portion of the video data is a first portion of the video data, and the attribute is a first attribute, determining, based at least in part on the instruction, a second portion of the video data requiring a smaller amount of storage than the video data, determining, based at least in part on the instruction and the second portion of the video data, a second attribute associated with the second portion of the video data such that a limited amount of video data is processed in a manner that saves processing power, wherein the second attribute corresponds to the instruction, and updating the output data based at least in part on the second attribute.

Additionally, or alternatively, the method 1400 may further include, wherein the user input is first user input, and the attribute is a first attribute, receiving second user input that is responsive to the representation, wherein the second user input includes an indication of a second attribute, determining a correlation between the first attribute and the second attribute, and updating the output data based at least in part on the correlation.

Additionally, or alternatively, the method 1400 may further include, wherein the video data comprises a first attribute and a second attribute, determining a first correlation between the first attribute and the instruction, determining a second correlation between the second attribute and the instruction, determining whether the first correlation or the second correlation exceeds a threshold, and based at least in part on the first correlation exceeding the threshold, determining the output data based at least in part on the first attribute instead of the second attribute, or based at least in part on the second correlation exceeding the threshold, determining the output data based at least in part on the second attribute instead of the first attribute.

Additionally, or alternatively, the method 1400 may further include generating, based at least in part on the video data, a machine learning model configured to determine attributes associated portions of video data, and determining, based at least in part on the instruction and the machine learning model, the attribute associated with the portion of the video data.

Additionally, or alternatively, the method 1400 may further include, wherein the portion of the video data is a first portion of the video data, and the attribute is a first attribute, receiving second video data, determining, based at least in part on the instruction, a portion of the second video data requiring a smaller amount of storage than the second video data, determining, based at least in part on the instruction and the portion of the second video data, a second attribute associated with the portion of the second video data such that a limited amount of the second video data is processed in a manner that saves processing power, wherein the second attribute corresponds to the instruction, and determining an aggregation of the first attribute and the second attribute, wherein determining the output data is further based on the aggregation.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

1. A method comprising:
receiving first user input data from a first user of a hiring entity, the first user input data indicating a selection of a first characteristic from a group of characteristics, wherein the first characteristic is based at least in part on qualifications associated with a position at the hiring entity, such that a limited amount of the group of characteristics is processed in a manner that saves processing power;
based at least in part on the selection of the first characteristic, determining first prompts from a group of prompts, wherein the first prompts at least partially correspond to the first characteristic, such that a limited amount of the group of prompts is processed in a manner that saves processing power;
receiving second user input data from a second user, wherein the second user input data includes video data indicating a response to the first prompts;
generating a first machine learning model based at least in part on training data, the first machine learning model being configured to determine user characteristics based on weights associated with the video data of users, and wherein generating the first machine learning model further comprises:
generating embeddings for the first machine learning model based at least in part on the second user input data such that the first machine learning model identifies outliers in the video data of users and processes a portion of the video data of users using a first quantity of computing resources instead of the video data of users using a second quantity of computing resources; and
updating the weights based at least in part on feedback data associated with the training data to generate updated weights, wherein the updated weights are associated with a first performance metric and the weights are associated with a second performance metric;
determining, based at least in part on the response to the first prompts and by the first machine learning model, first user characteristics associated with the second user, wherein the first user characteristics at least partially include personality traits associated with the second user;
determining a correlation between the first characteristic and the first user characteristics;
determining, based at least in part on the correlation and by a second machine learning model, a score associated with the second user and the position at the hiring entity; and
transmitting a representation of the score to the first user.

2. The method of claim 1, wherein the correlation is a first correlation, and the score is a first score, the method further comprising:
receiving the first user input data from a first user, the first user input data indicating a selection of a second characteristic from the group of characteristics;
based at least in part on the selection of the second characteristic, determining second prompts from the group of prompts, wherein the second prompts at least partially correspond to the second characteristic;
receiving the second user input data from the second user, wherein the second user input data is further based at least in part on the second prompts;
determining, based at least in part on the second user input data and by the first machine learning model, second user characteristics associated with the second user;
determining a second correlation between the second characteristic and the second user characteristics;
determining, based at least in part on the second correlation and by the second machine learning model, a second score associated with the second user and the second characteristic; and
transmitting a representation of the second score to the first user.

3. The method of claim 1, wherein the correlation is a first correlation, and the score is a first score, the method further comprising:
receiving third user input data from a third user, wherein the third user input data is based at least in part on the first prompts;
determining, based at least in part on the third user input data and by the first machine learning model, second user characteristics associated with the third user;
determining a second correlation between the first characteristic and the second user characteristics;
determining, based at least in part on the second correlation and by the second machine learning model, a second score associated with the third user and the first characteristic; and
transmitting a representation of the second score to the first user.

4. The method of claim 1, wherein the second user input data comprises at least one of video data or audio data, the method further comprising:
applying one or more transformations to the second user input data to generate text data representing the second user input data;
receiving third user input from the first user, the third user input indicating a selection of a portion of the text data; and
storing a representation of the portion of the text data.

5. The method of claim 2, the method further comprising:
receiving the first user input data from a first user, the first user input data further indicating a priority associated with the first characteristic;
determining, based at least in part on the priority, a first weight associated with the first characteristic, wherein the first weight is applied to the first score; and
determining, based at least in part on the priority, a second weight associated with the second characteristic, wherein the second weight is applied to the second score.

6. The method of claim 5, the method further comprising:
determining, based at least in part on the first weighted score and the second weighted score, an overall score associated with the second user; and
transmitting a representation of the overall score to the first user.

7. The method of claim 1, wherein the first machine learning model is configured to determine user characteristics associated with users based on at least one of video data or audio data, and the second machine learning model is configured to determine scores associated with the users based on the user characteristics.

8. A system comprising:
one or more processors; and
one or more computer-readable media storing instructions that, when executed by the one or more processors, cause the one or more processors to perform operations comprising:
receiving first user input data from a first user, the first user input data indicating a selection of a first characteristic from a group of characteristics such that a limited amount of the group of characteristics is processed in a manner that saves processing power;
based at least in part on the selection of the first characteristic, determining first prompts from a group of prompts, wherein the first prompts at least partially correspond to the first characteristic, such that a limited amount of the group of prompts is processed in a manner that saves processing power;
receiving second user input data from a second user, wherein the second user input data is based at least in part on the first prompts;
generating a first machine learning model based at least in part on training data, the first machine learning model being configured to determine user characteristics based on weights associated with input data of users, and wherein generating the first machine learning model further comprises:
generating embeddings for the first machine learning model based at least in part on the second user input data such that the first machine learning model identifies outliers in the input data of users and processes a portion of the input data of users using a first quantity of computing resources instead of the input data of users using a second quantity of computing resources; and
updating the weights based at least in part on feedback data associated with the training data to generate updated weights, wherein the updated weights are associated with a first performance metric and the weights are associated with a second performance metric;
determining, based at least in part on the second user input data and by the first machine learning model, first user characteristics associated with the second user;
determining a correlation between the first characteristic and the first user characteristics;
determining, based at least in part on the correlation and by a second machine learning model, a score associated with the second user and the first characteristic; and
transmitting a representation of the score to the first user.

9. The system of claim 8, wherein the correlation is a first correlation, and the score is a first score, the operations further comprising:
receiving the first user input data from a first user, the first user input data indicating a selection of a second characteristic from the group of characteristics;
based at least in part on the selection of the second characteristic, determining second prompts from the group of prompts, wherein the second prompts at least partially correspond to the second characteristic;
receiving the second user input data from the second user, wherein the second user input data is further based at least in part on the second prompts;
determining, based at least in part on the second user input data and by the first machine learning model, second user characteristics associated with the second user;
determining a second correlation between the second characteristic and the second user characteristics;
determining, based at least in part on the second correlation and by the second machine learning model, a second score associated with the second user and the second characteristic; and
transmitting a representation of the second score to the first user.

10. The system of claim 8, wherein the correlation is a first correlation, and the score is a first score, the operations further comprising:
receiving third user input data from a third user, wherein the third user input data is based at least in part on the first prompts;
determining, based at least in part on the third user input data and by the first machine learning model, second user characteristics associated with the third user;
determining a second correlation between the first characteristic and the second user characteristics;
determining, based at least in part on the second correlation and by the second machine learning model, a second score associated with the third user and the first characteristic; and
transmitting a representation of the second score to the first user.

11. The system of claim 8, wherein the second user input data comprises at least one of video data or audio data, the operations further comprising:
applying one or more transformations to the second user input data to generate text data representing the second user input data;
receiving third user input from the first user, the third user input indicating a selection of a portion of the text data; and
storing a representation of the portion of the text data.

12. The system of claim 9, the operations further comprising:
receiving the first user input data from a first user, the first user input data further indicating a priority associated with the first characteristic;
determining, based at least in part on the priority, a first weight associated with the first characteristic, wherein the first weight is applied to the first score; and
determining, based at least in part on the priority, a second weight associated with the second characteristic, wherein the second weight is applied to the second score.

13. The system of claim 12, the operations further comprising:
determining, based at least in part on the first weighted score and the second weighted score, an overall score associated with the second user; and
transmitting a representation of the overall score to the first user.

14. The system of claim 8, wherein the first machine learning model is configured to determine user characteristics associated with users based on at least one of video data or audio data, and the second machine learning model is configured to determine scores associated with the users based on the user characteristics.

15. A non-transitory computer-readable medium storing having instructions stored thereon that, when executed by one or more processors, cause the one or more processors to perform operations comprising:
receiving first user input data from a first user, the first user input data indicating a selection of a first characteristic from a group of characteristics;
based at least in part on the selection of the first characteristic, determining first prompts from a group of prompts, wherein the first prompts at least partially correspond to the first characteristic;
receiving second user input data from a second user, wherein the second user input data is based at least in part on the first prompts;
generating a first machine learning model based at least in part on training data, the first machine learning model being configured to determine user characteristics based on weights associated with input data of users, and wherein generating the first machine learning model further comprises:
generating embeddings for the first machine learning model based at least in part on the second user input data such that the first machine learning model identifies outliers in the input data of users and processes a portion of the input data of users using a first quantity of computing resources instead of the input data of users using a second quantity of computing resources; and
updating the weights based at least in part on feedback data associated with the training data to generate updated weights, wherein the updated weights are associated with a first performance metric and the weights are associated with a second performance metric;
determining, based at least in part on the second user input data and by the first machine learning model, first user characteristics associated with the second user;
determining, based at least in part on the second user input data and by a first machine learning model, first user characteristics associated with the second user;
determining a correlation between the first characteristic and the first user characteristics;
determining, based at least in part on the correlation and by a second machine learning model, a score associated with the second user and the first characteristic; and
transmitting a representation of the score to the first user.

16. The non-transitory computer-readable medium of claim 15, wherein the correlation is a first correlation, and the score is a first score, the operations further comprising:
receiving the first user input data from a first user, the first user input data indicating a selection of a second characteristic from the group of characteristics such that a limited amount of the group of characteristics is processed in a manner that saves processing power;
based at least in part on the selection of the second characteristic, determining second prompts from the group of prompts, wherein the second prompts at least partially correspond to the second characteristic such that a limited amount of the group of prompts is processed in a manner that saves processing power;
receiving the second user input data from the second user, wherein the second user input data is further based at least in part on the second prompts;
determining, based at least in part on the second user input data and by the first machine learning model, second user characteristics associated with the second user;
determining a second correlation between the second characteristic and the second user characteristics;
determining, based at least in part on the second correlation and by the second machine learning model, a second score associated with the second user and the second characteristic; and
transmitting a representation of the second score to the first user.

17. The non-transitory computer-readable medium of claim 15, wherein the correlation is a first correlation, and the score is a first score, the operations further comprising:
receiving third user input data from a third user, wherein the third user input data is based at least in part on the first prompts;
determining, based at least in part on the third user input data and by the first machine learning model, second user characteristics associated with the third user;
determining a second correlation between the first characteristic and the second user characteristics;
determining, based at least in part on the second correlation and by the second machine learning model, a second score associated with the third user and the first characteristic; and
transmitting a representation of the second score to the first user.

18. The non-transitory computer-readable medium of claim 15, wherein the second user input data comprises at least one of video data or audio data, the operations further comprising:
applying one or more transformations to the second user input data to generate text data representing the second user input data;
receiving third user input from the first user, the third user input indicating a selection of a portion of the text data; and
storing a representation of the portion of the text data.

19. The non-transitory computer-readable medium of claim 16, the operations further comprising:
receiving the first user input data from a first user, the first user input data further indicating a priority associated with the first characteristic;
determining, based at least in part on the priority, a first weight associated with the first characteristic, wherein the first weight is applied to the first score; and
determining, based at least in part on the priority, a second weight associated with the second characteristic, wherein the second weight is applied to the second score.

20. The non-transitory computer-readable medium of claim 19, the operations further comprising:
determining, based at least in part on the first weighted score and the second weighted score, an overall score associated with the second user; and
transmitting a representation of the overall score to the first user.
